(19) United States
(12) Patent Application Publication
(10) Pub. No.: US 2022/0018109 A1
(43) Pub. Date: Jan. 20, 2022

(54) Nested Infiltration Surfaces, Treatment Media, and Distribution Media

(71) Applicant: David A. Potts, Lyme, CT (US)

(72) Inventor: David A. Potts, Lyme, CT (US)

(21) Appl. No.: 17/374,631

(22) Filed: Jul. 13, 2021

Related U.S. Application Data
(60) Provisional application No. 63/051,693, filed on Jul. 14, 2020.
(60) Provisional application No. 63/051,707, filed on Jul. 14, 2020.
(60) Provisional application No. 63/058,857, filed on Jul. 30, 2020.

(51) Int. Cl. E03F 1/00; B01D 39/20; B01D 39/08

(52) U.S. Cl. CPC E03F 1/002; B01D 39/083; B01D 39/2068; B01D 39/2055

(57) ABSTRACT

Nested bands of treatment media and distribution media in an infiltration area are described. These nested bands may be positioned to promote water flow to and through the infiltration area. The nested bands may be linear or non-linear and may be vertically elongated such that they have installation depths deeper than conventional infiltration areas.

### CROSS-REFERENCES TO RELATED APPLICATIONS

This application claims priority to three U.S. provisional applications: application number U.S. 63/051,693, filed on Jul. 14, 2020 and entitled “Nested Infiltration Surfaces”; application number U.S. 63/051,707, filed Jul. 14, 2020 and entitled “Leaching Structure with Treatment Media and Distribution Media”; and application number U.S. 63/058,857, filed on Jul. 30, 2020 and entitled “Leaching Structure with Treatment Media and Distribution Media”. Each of the '693 application, the '707 application, and the '857 application is incorporated by reference herein, in its entirety, into this application.

### TECHNICAL FIELD

This application regards systems, apparatus, articles of manufacture, and processes involving wastewater, stormwater, septic systems, and the like. More specifically, this application regards infiltration fields comprising treatment media, distribution media, and nested infiltration surfaces as employed in such systems, apparatus, articles, and processes.

### BACKGROUND

Water having various sources including wastewater, storm water, and process water (all of which may herein be collectively referred to as “water” may be treated. Water treatment systems vary in size and scope. They can be sized for treatment of large amounts of water from a municipality or other large cumulative systems for benefitting many residences, businesses, and industrial facilities serviced by the municipality. The water treatment system can also be designed and sized for single home residential use and small scale residential and commercial uses benefitting single or few residences, businesses, and industrial facilities.

A water treatment system will often include a septic tank or system or other more complex treatment tank or system (“tank”), which can receive water, allow for solids from the water to settle or filter out and remove one or more of: Biological Oxygen Demand (BOD), Total Suspended Solids (TSS), nitrogen, Phosphorus, bacteria and/or pathogens, among other constituents. A water treatment system will also often include an infiltration system downstream of the tank for receiving the water from the tank, treating the water, and for discharging the water back to the environment for further treatment and/or groundwater recharge. An infiltration system can be comprised of various components, such as pipes or other channels lying atop a bed of stone, synthetic media, concrete, and plastic galleries.

Cesspools, drywells, galleries, chambers, trenches, beds, and deep leaching pits, collectively referred to herein as “dry wells” or “leaching structures,” are hollow with infiltrative surfaces on their outer perimeter and/or their bottom. These dry wells have been banned from use in many jurisdictions because of poor treatment performance.

### BRIEF DESCRIPTION OF THE DRAWINGS

FIG. 1 shows a side schematic view of an infiltration field system, as may be employed in embodiments.

FIG. 2 illustrates a cross-sectional view of an infiltration field, as may be employed in embodiments.

FIG. 3 shows a cross-sectional view of an infiltration field as may be employed in embodiments.

FIG. 4 shows a cross-sectional view of an infiltration field with a leaching structure as may be employed in embodiments.

FIG. 5 shows a cross-sectional view of an infiltration field without a leaching structure, as may be employed in embodiments

FIG. 6 shows a cross-sectional view of an exemplary closed loop infiltration band, as may be employed in embodiments.

FIG. 7 shows a cross-sectional schematic view along line A-A′ of FIG. 6, as may be employed in embodiments.

FIG. 8 shows a side cross-sectional view of an infiltration field with multiple bands of treatment media and distribution media positioned within a leaching structure, as may be employed in embodiments.

FIG. 9 shows a schematic top view of infiltration fields with equalization channels, as may be employed in embodiments.

FIGS. 10-11 each shows a schematic cut-away view of a section of an infiltration field with leaching structure, as may be employed in embodiments.

FIG. 12 shows a schematic side cross-sectional view of a water treatment system with infiltration field having multiple stacked leaching structures, as may be employed in embodiments.

FIGS. 13A-13B each shows a top view of an example of a leaching structure with spacers, as may be employed in embodiments.

FIG. 13C shows a side view of a geogrid with funnel material, as may be employed in embodiments.

FIG. 14 shows a cross-sectional side view of an infiltration field with treatment media and distribution media, as may be employed in embodiments.

FIG. 15 shows a top-down cross-sectional view of treatment media bands, distribution media bands and a leaching structure wall of an infiltration field, as may be employed in embodiments.

FIG. 16 shows a side cross-section of an infiltration field with leaching structure, treatment media and distribution media, as may be employed in embodiments.

FIG. 17 shows a cross-sectional view of bands of treatment media and distribution media surrounding an internal perforated polymer conduit, as may be employed in embodiments

FIG. 18 shows a side cross-sectional view of an infiltration field with leaching structure, as may be employed in embodiments.

FIG. 19A shows a side view of a leaching structure as may be employed in an infiltration field of embodiments.

FIG. 19B shows a side view of a leaching structure as may be employed in an infiltration field of embodiments.

FIG. 20A shows a side cross-sectional view of an infiltration field with leaching structure, as may be employed in embodiments.

FIG. 20B shows a top view of the infiltration field of FIG. 20A, as may be employed in embodiments.

FIG. 21A shows a top view of formwork that may be employed to shape bands of distribution media and treatment media, as may be employed in embodiments.

FIG. 21B shows a side view of formwork that may be employed to shape bands of distribution media and treatment media, as may be employed in embodiments

FIG. 21C shows a sideview and tab detail of formwork components that may be employed to shape bands of distribution media and treatment media, as may be employed in embodiments.

### DETAILED DESCRIPTION

Embodiments may be directed to process, apparatus, and manufacture involving nested infiltration surfaces, treatment media, and/or distribution media, as may be employed in water treatment systems. These water treatment systems may include “deep” installation depths of twenty-four inches to five feet, to eight feet to twenty feet to fifty feet and beyond. These water treatment systems may include vertically elongated infiltration fields in these depths. These deeper installation depths and the vertically elongated configuration of infiltration systems, their bands, or other components may provide enhanced infiltration area per square ground plat surface area when compared to shallower systems. The installation depths and/or vertically elongated configurations of the systems, their bands, or other components may extend below less permeable soil horizons, perma-frost levels, etc. or just be vertically oriented in areas where space constrains exist. Some installations may involve deep installation techniques such as clam-shell buckets, vertical boring equipment, drilling rigs, long-extended boom excavators, etc.

In certain embodiments, water may be supplied to various discrete elevations of a deep installation such that water may not be overloading some areas of the infiltration column while not reaching other areas of the infiltration column. Distribution boxes providing water delivery to different depths of the column as well as other zoned water delivery techniques to discrete regions of the infiltration column may be employed in embodiments.

Some embodiments may comprise water storage structures and recirculation conduits and systems. The water storage structures may be positioned below portions of an infiltration field and may capture and store water from the infiltration system for reuse. The water storage structures may be rigid or flexible and supported by the surrounding soil structure and may comprise various materials, such as concrete, metal, polymer, plastic, fiberglass, carbon, etc. and may be in fluid communication with a recirculation system that it can pump water from the storage structure and return it to the infiltration field. The recirculation conduits may be pipes or other structures and may be positioned in or around the water storage structure to draw water stored in the structure and/or overflowing from the storage structure for recirculation or reuse.

Some embodiments may comprise nested infiltration surfaces with or without leaching structures such as an existing dry well or a newly installed dry well or other structure installed with the nested infiltration surfaces. Nested infiltration surfaces of embodiments may be located at the interfaces between nested bands of distribution media and nested bands of treatment media within a dry well or other structure, as well as in the absence of a dry well or other structure. These bands of distribution media and treatment media, and intervening infiltration surfaces, may be fed water from a pressurized or unpressurized dosing conduit (e.g., dosing pipe, dosing channel, etc.) and may serve to support treatment of the water as it flows through the treatment media, the distribution media, and the infiltration surfaces of embodiments.

Leaching structures of embodiments may have different configurations, installation depths, sizes and features, including different combinations of the features shown herein. These configuration changes may include the design of and materials comprising the leaching structure walls themselves, as well as the materials comprising the treatment media, the materials comprising the distribution media, the installation depth of one or more infiltration fields, the height of the infiltration column, and the materials, if any, comprising the infiltration surfaces. For example, some infiltration fields of a system may employ non-sandy soil as a treatment media, while other leaching infiltration fields may employ sand as a treatment media. Likewise, the distribution media may be different between different leaching structures of an infiltration field. Similarly, the distribution media may be different between different bands within a single leaching structure having multiple nested bands of treatment media and infiltration media.

Thus, for example, a system may have a first leaching structure with sand treatment media and stone aggregate distribution media, while a second leaching structure may have non-sandy treatment media and cuspated three-dimensional grid as a distribution media. Moreover, this first leaching structure may be adjacent to the second leaching structure and may be set multiple feet below the surface and/or the second leaching structure may be deeper than the first leaching structure and may even be below or directly below the first leaching structure. An infiltration system with or without a leaching structure and with one or more bands of treatment media and distribution media may be vertically oriented. Vertically oriented should be understood to comprise when a height or depth is twice or more larger than a width of a measured infiltration system, band or leaching structure. In other words, vertically elongated means that a component or system has a height/depth to width aspect ratio of 2 or larger. This can include ratios of 2, 3, 4, 5, 10, 15, 20, 25, 30, 35, 40, 50, or 100 or more and intervening ratios as well. Horizontal layers of treatment media and/or infiltration media may also be present in embodiments.

In embodiments, an exemplary multiple band infiltration field may employ sand as one treatment media, non-sandy soil as a second treatment media, stringy plastic mat as a first distribution media, and stone aggregate as a second treatment media. Other combinations, with and without leaching structures, and other materials may also be used in embodiments.

Embodiments may provide ways to maximize the infiltrative surface areas available for infiltration fields constrained by land plot size and may improve the associated treatment performance. Embodiments can be used with new infiltration field systems and to retrofit existing infiltration field systems.

Leaching structure(s) as used herein may refer to a single or multiple rigid outer structure(s), like a dry well, and may be constructed with or without treatment media positioned therein or positioned outside, and with or without distribution media positioned therein or positioned outside. Leaching structure walls may comprise concrete, steel, polymer, carbon fiber laminate, or other material and may preferably comprise a rigid material having a sufficient compressive loading strength to resist soil and traffic forces to which it may be subjected. Embodiments may nest bands of infiltrative surfaces with or without leaching structures and may provide increased infiltrative surfaces per ground surface area when compared to an infiltration field employing a single, un-nested infiltrative surface. Embodiments may employ infiltration surfaces with significant heights, i.e., be vertically elongated, such that their installation depth is deeper than previous systems. In addition to tall infiltration surfaces of infiltration fields, these fields may be themselves installed deep into the group and stacked atop one another so as to increase the amount of infiltrative surface area available for the surface area of the land. These installation depths may be four feet or more below the surface in some embodiments and may require zoned water dosing conduit systems such that water is evenly distributed to the various areas and depths of an infiltration field. In other embodiments, water can be directed to some sections and not others to facilitate treatment, or resting/recovery of infiltration rates. Horizontal layers of treatment media and/or infiltration media may also be present in embodiments.

In embodiments, infiltration fields comprising infiltrative surfaces may comprise bands of distribution media that may have a smaller cross-sectional thickness than bands of adjacent or nearby treatment media in the infiltration field. In embodiments, distribution media may be configured in nested bands surrounding nested bands of treatment media. In other words, a band of distribution media may be partially or completely surrounded by a band of treatment media, which is itself partially or completely surrounded by a second band of distribution media, which is then partially or completely surrounded by a band of treatment media, etc. The interfaces between bands of treatment media and infiltration media may be considered infiltrative surfaces. These infiltrative surfaces may only be interfaces, or may also comprise geotextile fabric, such as filter fabric, or other material to maintain separation between the infiltration media and the treatment media. Geotextile fabric may include, for example, woven fabrics, non-woven fabrics, needle punched fabrics, heat bonded fabrics, and other fabrics generally capable of separating, filtering, reinforcing, protecting, and/or draining. Other materials, as well as no materials (e.g., direct contact between the media types), may maintain the separation between infiltration media and treatment media in embodiments. In embodiments, different numbers of bands may be employed, such as 2, 3, 4, 5, etc. The innermost band may be either treatment or distribution media. Likewise, the outermost band may be either treatment or distribution media. The treatment media bands may be homogenous or nonhomogeneous, i.e., without or with more than one different material therein. Likewise, distribution media may be homogenous or nonhomogeneous, i.e., without or with more than one different material therein.

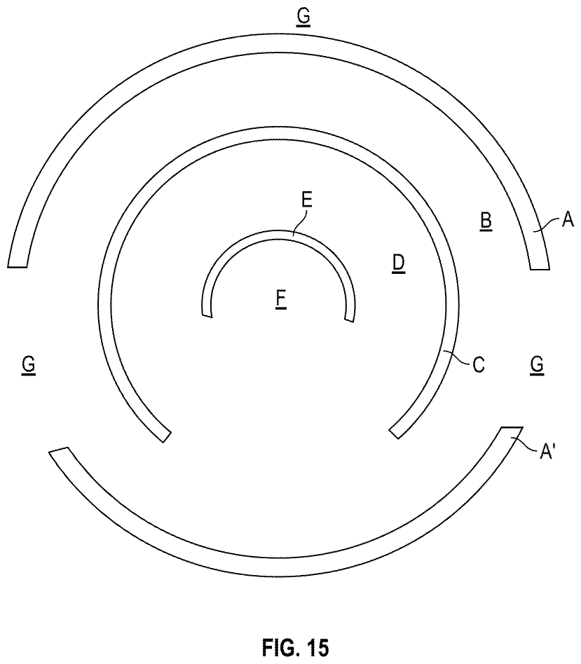

Nested infiltration surfaces as well as nested treatment media bands and nested distribution media bands may be positioned in groups and may be fed by one or more dosing pipes or other dosing systems. None, some, or all may also be vertically elongated as well. The nested bands of distribution media, treatment media, and intervening infiltration surfaces, may have circular cross-sections, polygonal cross-sections, elliptical cross-sections, and various other cross-sections as well. The bands may have different heights, with outer bands being shorter than inner bands or vice-versa. The bands may be closed loops like a circle, square, or hexagon, or may be partial loops like a horseshoe or the letter “C” or the letter “J”. Within a single set of nested bands, different bands may have different configurations. For example, on band may be a closed loop, where another band may be a partial loop. An example of such different configurations is illustrated, e.g., in FIG. 15. As noted above, these bands of treatment media, distribution media, and any intervening infiltration surfaces may be positioned within a leaching structure, as well as outside a leaching structure or without any associated leaching structure.

Leaching structures, such as dry wells, may comprise concrete as well as other materials and may have an open bottom, full perimeter walls, partial perimeter walls, a top with access areas for reaching the media within the structure, and/or a closed bottom. The walls of the leaching structure may comprise gaps or perforations, which may provide for water passage from within the leaching structure to outside the leaching structure. The leaching structure may be circular, may be polygonal, and may have other shapes as well. In some embodiments, the leaching structure may have previously served as a dry well, while in some embodiments the leaching structure may be installed concurrently with the internal treatment media and the internal distribution media. In certain embodiments the leaching structure may be preloaded with treatment and distribution media before delivery to the installation site or before placing the leaching structure in the ground. In other words, treatment media and/or distribution media may be loaded into a leaching structure before the leaching structure is placed in a hole or other final location. This pre-loading may occur at the job site or earlier in the manufacturing process.

In use, water may be dosed from a dosing conduit, such as a PVC pipe, into the top or a top region of an infiltration field, with or without a leaching structure, and this water may move downward and through distribution media and the treatment media positioned in the leaching field, until the water may ultimately be discharged into native soil, placed soil, a reclamation system, which may include a water storage structure for reuse and/or recirculation and suitable conduits to facilitate reuse and/or recirculation, or other discharge media. The water may be allocated to different areas of an infiltration field by a junction box or other diverter system such that different areas of the infiltration field can receive equal doses of water for subsequent treatment and handling. These areas of the infiltration field may be at different elevations and at different leaching structures.

Carbon treatment media may be employed in a leaching structure or other part of an infiltration field, or in an infiltration field without an associated leaching structure. This carbon treatment media may be present along the height of the infiltration field as well as at the top, bottom, or both of the infiltration field. Special regions of the infiltration field may be configured to house this carbon treatment media. For example, access panels and access conduits may be present to load, remove, and reload carbon treatment media of an infiltration field.

Without being restricted to a particular theory of operation, in use, as water enters the infiltration field, it may flow more quickly through the distribution media than through the treatment media. Because of this increased flow rate through the distribution media, the water may be distributed by the distribution media through and downward in the infiltration field. The water, as it travels, may more slowly penetrate into the treatment media, where the water may remain for a period of time to be treated while in the treatment media and before discharge from the infiltration field. In some embodiments the distribution media contacts other distribution media and, in some embodiments, there may be treatment media beneath the distribution media such that water always has to travel through a certain amount of treatment media so that treatment standards may be met. FIG. 14 shows an example of how treatment media may lie below each distribution media band, as may be employed in some embodiments.

The vertically elongated height/depth of the infiltration field and its nested bands of treatment media and distribution media, e.g., nested infiltration surfaces, may allow for improved septic loading per land surface area when compared with conventional water leaching systems, such as conventional dry wells. In other words, and for example, a conventional circular dry well may have a six-foot diameter and be six-feet deep. Comparatively, a nested infiltration field with a plurality of nested infiltration surfaces in and around such a dry well can provide more infiltration surface area as numerous infiltration surfaces reside where only a single one had before, while still maintaining or being similar to the six-foot diameter and six-foot depth of the conventional circular dry well. Thus, embodiments may present more infiltrative surface area than a single dry well. The amount of infiltrative surface area for a closed circular loop of infiltrative surface may be estimated with geometry. For example, for a closed cylindrical loop, the surface area of infiltrative surface, can include both inner and outer surfaces of the cylinder. Thus, in embodiments, the infiltrative surface area may be increased by adding bands of distribution media and treatment media within the dry well, outside of the drywell, or at other locations in or portions of an infiltration field. Each band provides additional interface surface above and beyond the single interface between the outer structure and the surrounding material of a single dry well structure. Accordingly, embodiments with a single additional band of treatment media or multiple bands of treatment media and distribution media may provide more infiltrative surface than an empty circular dry well having the same outermost perimeter size and configuration. With such increased total infiltrative surface per outermost perimeter occupied, the amount of water that may be processed for a certain amount of available land area, e.g., lot size and/or available overburden depth above groundwater levels, etc., may be increased. In other words, through the use of one or more nested infiltration surfaces, which provide for additional leaching area per available land area, improved infiltration may be provided when compared with a conventional dry well having a single infiltrative surface around its outer perimeter.

In some embodiments, the distribution media may preferably have a porosity that is greater than the treatment media. The increased porosity may provide for flow channels within the distribution media of an infiltration field. The flow channel may be the width of a band of distribution media. In other words, the thickness of a band of distribution media may allow water to flow within it and may be considered a flow channel. These flow channels may provide paths of less fluid resistance in which the water may pass in order to access a greater percentage of the infiltration field and the treatment media therein. The distribution media may include three-dimensional grids (e.g., cuspated panels, geogrid, Geomat® brand geogrid, etc.), aggregate, stone aggregate, plastic aggregate, stringy fiber mat, as well as other materials, and combinations thereof. Exemplary three-dimensional grids include Enkadrain drainage system product No. 9120 from Colbond Inc., P.O. Box 1057, Enka, N.C. 28728; and the several geogrids named Grasspave2, Gravelpave2, Rainstore2, Slopetame2, Draincore2, Surefoot4, Rainstore3 from Invisible Structures, Inc., 1600 Jackson Street, Suite 310, Golden, Colo. 80401.

Distribution media, when placed, is preferably highly permeable to water and structurally supportive. The treatment media may preferably be sand, or soil, perlite, biochar, peat, diatomaceous earth, or blends of these materials or other material having a porosity less than the porosity of the distribution media in the infiltration field. The treatment media may comprise or consist of a carbon source. Compared to distribution media, treatment media, when placed, is preferably conducive to treatment of water received from the dosing pipe or distribution media. This treatment may occur within the treatment media itself as well as at infiltrative interfaces between the treatment media or distribution media and another material, such as surrounding soil or distribution media. Infiltration interfaces of infiltration surfaces and/or nested infiltration surfaces may or may not employ geotextile fabric, such as filter fabric, or other geotextile material.

A band of either the treatment media or distribution media may be considered a three-dimensional volume comprising the width, height, and length of treatment media or distribution media, whether installed or prior to installation. Comparatively, a nested band of infiltration surfaces, while also a three-dimensional structure, may be better understood as an interface having a small thickness and more of a certain height, length and overall shape. Each interface may be spaced a uniform or non-uniform distance apart from a second or third etc. infiltration interface. These infiltration surfaces may or may not comprise geotextile fabric or other material and may simply lie along the interface between treatment media and distribution media. The nature of the treatment and distribution media may impact the specific thicknesses of the bands. Some media can be chosen for its ability to promote saturated or unsaturated flow conditions as desired.

Geotextile fabric, other filtering material, or other geotextile material may be present between some, all or none of the interfaces between the treatment media and the distribution media. Similarly, but independently, geotextile fabric, other filtering material, or other geotextile material may be present between some, all or none of the interfaces between the treatment media or distribution media and any adjacent material, such as in-situ soil, or placed material, also such as soil. Nested bands of infiltration surfaces may be in the shape of concentric circles, nested non-concentric circles, nested polygons, such as nested ellipses, rectangles or octagons, as well as in various other shapes. The shapes may be full loops or open ended (i.e., not connected back onto itself like a horseshoe or the letter “C” or the letter “J”). The nested bands may have a depth, when installed, of approximately three feet or less to approximately twelve feet or more. They may also have a corresponding width that qualify them as vertically elongated. The infiltration fields may be shaped such that the bands of treatment media and distribution media may form nested loops around one another. In other words, a first treatment media in an infiltration field may be surrounded by a first distribution media, that is itself surrounded by a second treatment media, that is itself surrounded by a second distribution media, etc. The bands of treatment media and distribution media may be separated by geotextile fabric, such as filter fabric, or another material, or may not have a separating material and may interface directly with each other. The treatment media bands may be approximately four inches to approximately eighteen inches or more in width while the distribution media bands may be approximately three-quarters of an inch to approximately four inches in width. Other widths for each band may be employed as well and the deeper the bands, the wider they may be in order to account for flow through a given cross section. Moreover, in a single infiltration field, different bands of treatment media may have different widths, and different bands of distribution media may have different widths. Horizontal layers of treatment media and/or infiltration media, with or without intervening geotextile, may also be present in embodiments.

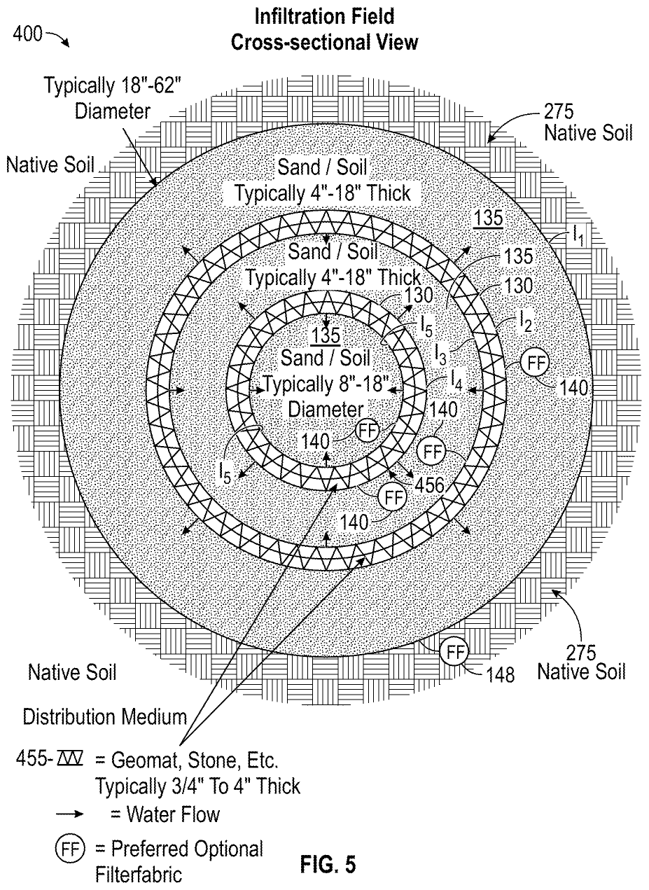

Sizing of an infiltration field or a series of infiltration fields to support a water flow, may be determined by considering the total surface area of the interface between each band of media in an infiltration field and the cumulative amount of interface area for all of the infiltration fields in a specific leaching system. For example, the surface area of the two nested cylinders of distribution media in FIG. 5 may be considered in addition to the surface area of the outermost interface between the structure wall/outermost stone and the native soil, and this cumulative number may be considered the interface surface area for the infiltration field of FIG. 5. As can be seen, there are five treatment media interfaces for the infiltration field of FIG. 5 (I₁-I₅). Thus, more surface area than the outermost treatment media interface is provided in embodiments. This increased surface area for treatment interface can be advantageous in reducing the amount of land area needed for an infiltration field system, especially when compared to conventional dry wells, such as leaching galleries.

In use, an infiltration field may be constructed in phases through the use of one or more leaching structures, such as cylindrical dry wells having one or more nested infiltration surfaces therein. Each leaching structure can be sized to serve a bedroom or other measurable unit for treatment of water in a leaching system. When more flow is present, e.g., more bedrooms or another flow source, additional leaching structures with nested infiltration surface bands may be added to the infiltration field to increase the treatment and hydraulic capabilities of a system as a whole. Also, in embodiments, a traditional leaching structure may be modified using methodology taught herein—for example, by building internal surface area with nested bands of treatment media and distribution media to form nested infiltration surfaces within an existing structure. Further, an infiltration field may be constructed in phases through the use of one or more sets of bands of distribution media and treatment media, without associated leaching structures. As in embodiments where leaching structures are present, each set of bands can be sized to serve a bedroom or other measurable unit for treatment of water in a leaching system. Additionally, in a single infiltration field, both leaching structures having one or more nested infiltration surfaces therein and bands of distribution media and treatment media, without associated leaching structures, may be employed together.

In use, an infiltration field may be installed in an excavation and supported at each end with temporary or permanent supports and may be backfilled from above or otherwise such that the backfill treatment media interfaces with the upright outer surfaces of the geotextile or other material, such as leaching structure walls or outer bands of treatment or distribution media. Once backfilled, the infiltration field may be covered with additional geotextile, sand, a plastic impermeable cover, grass, pavers, asphalt, concrete and other materials as well. For oxygenation or other purposes, the infiltration field, including any leaching structure, may be six inches or more below finished grade, although other depths, including two, five, eight, twelve, fifteen, twenty, fifty, and one hundred or more feet below grade may be employed in embodiments. The infiltration system may itself have an overall aspect ratio such that it may be considered to be vertically elongated as well. Vents, vacuum pumps and blowers may also be utilized for aeration purposes. As noted above, installation may be carried by various means such as vertical boring equipment, clamshell bucket diggers, drill rigs, long extended excavators, etc.

In embodiments, infiltration fields may be connected in series, in parallel and in combinations of series and parallel. These series and parallel connections may be both in horizontally oriented infiltration fields where each field is at approximately the same invert elevation as well as in vertically oriented infiltration columns where each column may be at lower invert elevations and even directly below an upper infiltration field.

Infiltration fields may be constructed offsite and brought to an installation site as discrete structures/modules. Then, ahead of or during installation, the structures/modules of an infiltration field may be configured into their final positions, filled with distribution media and treatment media, and fed by one or more dosing pipe to be used as a leaching field. The treatment and distribution media may also be installed offsite, prior to installation and then finally assembled and connected at the installation site. The use of light weight distribution and treatment media may be incorporated to reduce weight for lifting and moving the units around. The bottoms of the structures/modules preloaded with media can be made from perforated, permeable or unperforated concrete or other materials. Open bottom surfaces can also be outfitted with rebar grids, chain link, fencing, cable grids, geotextile materials such as geogrids, fabrics, boards, sheeting etc., that can suitably support the loads associated with lifting and move the preloaded media. Sealed bottom embodiments can also be perforated or made permeable in the field prior to backfill. An example would be to employ knock outs of thinner concrete material on the bottom and/or lower portion of the structure/module. Other materials, such as plastic structures/modules, would also be equally useable.

Various designs and materials may be employed in embodiments. PVC pipe or other pipe material may be employed as a support and/or dosing conduit. In embodiments, the fabric or membrane or another interface material may preferably be hygroscopic or hygroscopically treated. In embodiments, a preferred thickness (width) for the distribution medium band may be approximately 0.75″-4″ or so such that the distribution medium channels have a stoutness that promotes long term flow of water and installation alignment. These thicknesses may be associated with a depth such that the distribution media may be considered to be vertically elongated.

Embodiments may comprise equalization channels that can promote the transfer of water between bands and/or within bands. Such equalization channels may provide for redistribution of water between bands if one or a grouping of bands is overloaded with water or has a greater amount of water than other bands of an infiltration field. The channels may comprise pipes piercing through a band of treatment media and connecting two bands of distribution media. Also, the equalization channels may connect other bands of media, for instance, two bands of treatment media and/or while also passing through a wall of a leaching structure. In so doing, the equalization channels may serve to manage water loading in and around an infiltration field. Where water levels are higher in one section of an infiltration field, this water may be diverted to another area of the infiltration field via one or more equalization channels.

The infiltration fields may receive water from supply lines and dosing pipes in series and in parallel configurations. And the infiltration fields may be further coupled to other infiltration fields as well as to downstream treatment systems, to recirculate water, to vents, and to other outputs as well. Infiltration fields may also include clean-outs for replacing or servicing denitrification media or for other purposes as well.

The infiltration field may comprise various materials and may be closed loops, i.e., closed bands, or have open ends. Various materials may be used to construct the infiltration field, including geotextile, a flat pipe or plat pipe equivalent, flat panels, plastic, fiberglass and cuspated panels, and concrete. In embodiments, an outer concrete wall or other wall material, such as steel, or carbon fiber laminate may comprise a leaching structure and this may interface with treatment media, which may comprise a hygroscopic material. Any inner material may be porous or otherwise allow water to pass through. The structure wall may also be permeable or impermeable depending on the circumstance.

During installation, a support matrix may be used to support the distribution media and allow the leaching media and other portions of the infiltration field to be assembled into a final installation depth, size, or other location parameter. This support matrix may further enable soil, such as sand, or polymer granules, or another treatment media to be placed between leaching structures as well as within infiltration fields. The distribution media may also provide support during installation. In preferred embodiments, the placement of any outermost stone or other material should provide minimal disturbance to the positioning of the infiltration fields after nested infiltration surfaces are positioned in their final installed position. Various supports may be employed to support the dosing conduits with respect to the infiltration fields. These supports may be placed at edges or other surfaces of the ends of each infiltration field, along the tops of the infiltration field, and at other positions as well. These supports may be permanent as well as removable. Permanent supports may remain with the water infiltration field after the installation is complete while removeable supports may be removed once the media is installed or the infiltration field is otherwise supported during installation. Some embodiments may employ combinations of permanent and removeable supports. Supports can include flexible materials like geotextile fabric, such as filter fabric, as well as more ridged structures like corrugated metal, corrugated plastic, or corrugated fiberglass walls.

Further to the above discussion, in embodiments, geosynthetic materials such as geogrids, geotextile fabrics, etc. maybe used alone or in combination with other materials such as rebar and other structural members, and cast into concrete, plastics, etc. or fixed onto the structural sidewalls, bottom or top to fabricate permeable walls to shape and contain distribution and treatment media to assist with the efficiency of forming the bands in the field.

During assembly or for design layouts, for example, an approximately 2-foot diameter perforated pipe or drywell can be placed inside an approximately 4-foot diameter drywell, which can be placed inside an approximately 6-foot diameter drywell, which can be placed in an approximately 8-foot diameter drywell. The stone can be placed on the outside of the approximately 8-foot diameter drywell. Sand, or other treatment media, could be placed between the approximately 8-foot and approximately 6-foot diameter drywells. Stone, or other distribution media, can be placed between the approximately 6 foot and approximately 4-foot diameter drywells. Sand can be placed between the approximately 4 foot and approximately 2-foot diameter drywells. Stone can be placed in the approximately 2-foot diameter drywell. This same methodology could be utilized with plastic, fiberglass etc. structures. This entire infiltration field may be positioned in a deep installation, such as an upper invert elevation of five feet, eight feet, fifteen feet or more.

Supports for the infiltration fields can include spacers, stakes, or other supports that hold bands apart during assembly. Materials can also be installed through the use of forms (e.g., metal, plastic, fiberglass, wood, etc.). These spacers, stakes, or other supports can be configured to perform various functions, including: to hold a distribution pipe atop an infiltration field; and to hold the nested bands in place for backfilling or assembly at the desired elevation and location. Certain supports, including certain stakes and braces, can also have connecting members and sockets to snap to nested bands and join them together at a specific distance apart to allow for sand or soil or other material backfilling.

In certain embodiments, a manifold may be placed in or near the bottom of an infiltration field. Like equalization channels, one or more manifolds may be configured to provide for collection and/or redistribution of water between most or all of the infiltration fields of a system. Certain bottom interconnecting manifold designs may also be employed. These bottom interconnecting embodiments, as well as other embodiments, may have an inspection port integrated into the manifold to monitor ponding levels and storage structure water levels. Inspection ports can also be placed into hydraulic communication without integration into the bottom interconnecting manifold. Also, inspection ports may be coupled to the bottom manifold or formed as part of the bottom manifold. These ports, as well as others, may be used to monitor water, system status, carbon source efficacy, and other things. Carbon sources, which may be added to other treatment media, or may be used as its own treatment media, may include sawdust, sugar, wood chips, molasses, and other carbon sources. Still further, the ports may be used for connection to other treatment systems including denitrification systems and additional leaching components.

Some embodiments may use gravity dosing while some may employ pressure distribution and/or pressure dosing. Systems employing both gravity and pressurized distribution may also be employed in embodiments. Some embodiments may use downflow and some may involve up flow configurations.

In embodiments, pressure distribution systems can be outfitted with distal head monitoring ports, and these ports may also be utilized for cleaning the orifices. And, rigid piping framework for distribution systems and/or dosing conduits may have a ladder configuration with the proximal and distal ends serving to provide a framework from which external and internal piping may be supported.

Embodiments may include multiple leaching structures placed atop one another and/or at different invert elevations for an infiltration field or for multiple infiltration fields. The infiltration fields may have open and closed tops and bottoms, and these tops and bottoms may be made from concrete, metal, fiberglass, or other material. These tops and bottoms may also be covered with a geotextile material. In embodiments, an infiltration field comprising one or more leaching structures may be sized such that water traveling through the system travels a suitable and acceptable distance according to needs, local rules and regulations, before the water is returned to the environment. Water may be recirculated or reused through the use of water storage structures placed below the infiltration system.

As described above, and shown in the following illustrations, water may enter top distribution media, travel through treatment media, move through bottom collection media, then travel through a different treatment media such as containing wood or another carbon source, enter a collection layer and exit the structure through the side or bottom of the structure. In other embodiments water may be introduced into the bottom of the distribution media and flow upwardly and into the treatment media.

Given the amount of water flow and the positioning of the distribution media and treatment media, certain layers and certain areas of an infiltration field may be saturated during use while others may be unsaturated. Distribution piping can also be configured to dose the desired load to individual distribution bands rather than apply to a top distribution media that is hydraulically connected to all distribution bands.

Embodiments may include an infiltration system comprising a first band comprising treatment media; being vertically elongated and having a height of three feet or more or less, a width, and a length where the length of the first band may form a non-linear shape, and the treatment media may have a first porosity. Embodiments may further comprise a second band comprising distribution media, where the second band may be vertically elongated and may have a height of three feet or more or less, a width, and a length. The length of the second band may form a non-linear shape and the second band may be positioned around or within the first band. The second band may have a second porosity where the second porosity may be greater than the first porosity. Also, the first band and the second band may be positioned within or outside of a drywell comprising a rigid material, and the drywell may have open passages sized to permit the passage of water from inside the dry well to outside the drywell.

In some embodiments, the drywell may be in the form of a rectangle or circle or square and an interface between a first band and a second band may comprise geotextile fabric. Also, some embodiments may comprise a dosing conduit positioned above a first band and above a second band. Still further, a third band may be present and may be positioned underneath the second band, the first band or both, and the third band may have a width of four inches or more or less and may have a height wherein the third band may be considered vertically elongated and may have a height being at least twice the width of the third band. In embodiments, the drywell of an infiltration system may comprise concrete, steel, polymer, or carbon fiber laminate. Still further horizontal layers of treatment media and/or infiltration media may also be present in embodiments. These layers may be present in a vertically elongated infiltration field even though they themselves are horizontal or substantially horizontal. In other words, a vertically elongated infiltration field may itself be comprised of layers of horizontal or substantially horizontal treatment media and/or distribution media. And this may also be present with one or more vertically elongated treatment media bands and/or vertically elongated distribution bands.

Embodiments may also comprise a first band comprising treatment media, the first band being vertically elongated and having a height of three feet or more or less, a width, and a length, the length of the first band forming a linear shape, and the treatment media having a first porosity; a second band, the second band comprising distribution media, the second band being vertically elongated and having a height of three feet or more or less, a width, and a length, the length of the second band forming a linear shape, the second band positioned around or within the first band, the second band having a second porosity, the second porosity being greater than the first porosity, wherein the first band and the second band are positioned within or outside of a drywell, and the drywell has open passages sized to permit the passage of water from inside the dry well to outside the drywell.

Embodiments may also comprise a first band, the first band comprising treatment media, the first band being vertically elongated and having a height of three feet or more or less, a width, a length, an installation depth of three feet or more or less, and a cross-sectional shape defined by height and the width, the cross-sectional shape configured as a polygon, wherein the treatment media has a first porosity; and a second band, the second band comprising distribution media, the second band being vertically elongated and having a height of two feet or more, a width, a length, and a cross-sectional shape defined by the height and the width, the cross-sectional shape configured as a polygon, the second band positioned around or within the first band, the second band having a second porosity, the second porosity being greater than the first porosity.

In embodiments, the bands may be in the form of a closed loop such as in in the form of a rectangle or circle or square and in some embodiments an interface between a first band and a second band or another material may comprise geotextile fabric.

Embodiments may comprise one or more dosing conduits positioned above or adjacent to a first band and/or a second band or other portion of an infiltration field.

Treatment media in embodiments may comprise sand, a carbon source, an iron containing substance or a substance for adjusting alkalinity or ph. Iron shavings or another iron source may be used to bind phosphorus. Stone being employed may be limestone, which can provide ph adjustment.

Embodiments may also comprise a water storage structure positioned below a first band or a second band or both, or another portion of an infiltration field and the water storage structure may be configured to store water, the water storage structure may be in fluid communication with a recirculation conduit, and the recirculation conduit may be positioned and configured to extract water from the water storage structure.

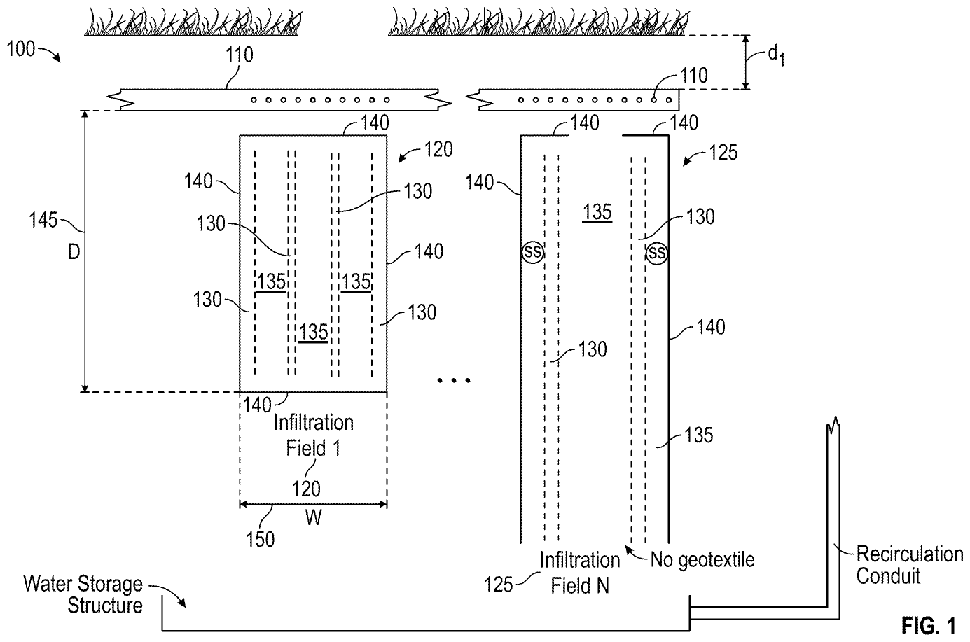

FIG. 1 shows an infiltration field system 100 as may be employed in embodiments. A dosing conduit 110 is shown above an array of infiltration fields, nos. 1 (120) through N (125). Distribution media 130, which is shown as a band of distribution media, such as stone, is shown in each infiltration field. Also shown is sand or soil as treatment media 135 in each infiltration field and a water storage structure is positioned below the infiltrations fields and has a recirculation conduit fluidly coupled thereto. Geotextile fabric 140 borders the entire infiltration field 120 while geotextile fabric 140 does not border the entire infiltration field N (125). Geotextile fabric, such as filter fabric, may also be present between the distribution media and the treatment media.

In embodiments, infiltration fields of a system may have depths 145 (or heights if not yet installed) that are at least approximately twice their width 150 or higher, i.e., they may be vertically elongated. However, infiltration fields may have shorter height relative to their widths as well. These can include height of approximately 1.1, 1.2, 1.3, 1.4, 1.5, 1.6, 1.7, 1.8, and 1.9 times the width of the infiltration field. Vertically elongated infiltration systems can have larger height to width aspect ratios. These ratios, of height to width may be 2, or three, or five, or ten or twenty or larger. Larger aspect ratios for vertically elongated infiltration fields and bands of these fields may be preferred as the larger aspect ratios can provide for greater infiltration area per surface area. Likewise, bands of treatment media and/or bands of distribution media may themselves have height to width aspect ratios within approximately these same ranges. Although sand/soil is illustrated, other treatment media 135 may be employed. The invert elevation to the top of the infiltration field is shown as di.

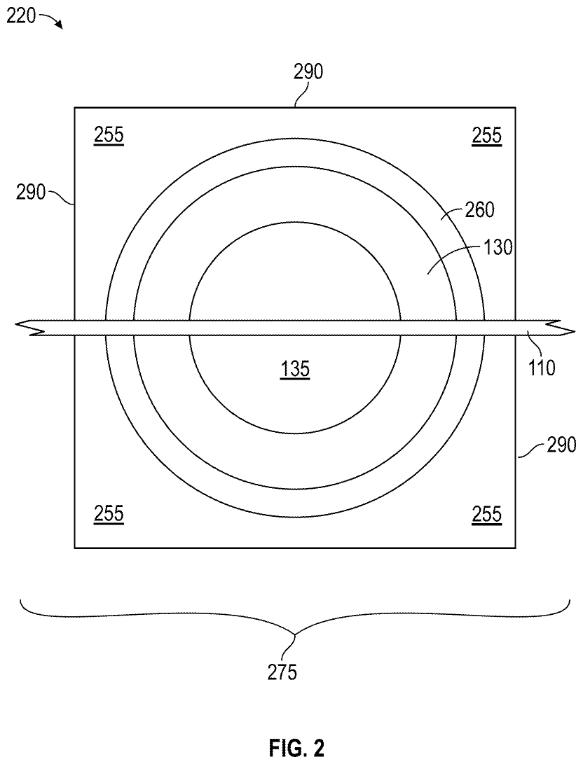

Infiltration fields 120 and 125 of system 100 may have different configurations and sizes. These configuration changes may include the design of the infiltration field itself as well as the materials comprising the infiltration field. For example, some infiltration fields of a system may employ non-sandy soil as a treatment media 135 while other infiltration fields may employ sand as a treatment media 135. Likewise, the distribution media 130, which is shown as a band in FIG. 1, may be different between infiltration fields as well as within infiltration fields having multiple bands. Thus, for example, a system may have a first infiltration field with sand treatment media and stone aggregate distribution media, while a second infiltration field of the same system may have non-sandy treatment media and cuspated three-dimensional grid as a distribution media. Still further, an exemplary nested multiple band infiltration field of an infiltration system may employ sand as one treatment media, non-sandy soil as a second treatment media, stringy plastic mat as a first distribution media and stone aggregate as a second treatment media. These varying bands of media may then be nested within each other in embodiments in full and partial bands. Other combinations, other materials, and other positions and orientations, may also be used in embodiments. For example, a leaching structure (see, e.g., FIG. 2 at 260), such as a dry well, may also be a component of a leaching field. Such a dry well may border the outside the leaching field and may also contain part of it and be surrounded by other parts of the leaching field. Thus, the various features shown in the figures and described herein may be combined in numerous fashions and may be present or not present in various combinations in exemplary systems.

FIG. 2 illustrates a cross-sectional view of an infiltration field 220 as may be employed in embodiments. This view shows distribution media 130, which has a circular cross-section and is inside a leaching structure 260. Optional placed media 255, which may be stone, is shown outside the leaching structure 260. The treatment media 135, which may be sand, is shown within the distribution media 130. In FIG. 2, the treatment media is shown as a circular band that mimics the shape of the leaching structure wall and surrounds treatment media that is itself columnar in shape. Native soil 275 is shown around the placed media 255. A dosing conduit 110 is shown above the infiltration field 220. In operation, the dosing conduit 110 will provide water into the infiltration field 220 and preferably into the distribution media and preferably not into the treatment media. The water may then be distributed by the distribution media into the treatment media. The interface between the distribution media and the treatment media may comprise geotextile fabric, such as filter fabric. This interface may be considered an infiltration surface within the infiltration field. Another infiltration surface may exist between the placed media and the native soil.

The outermost interface 290, which may have various shapes and may be roughly shaped or be shaped with forms and have a predefined shape, and is located between the stone 255 and the native soil 275, may be approximately eighteen inches to approximately sixty-two inches or more from a center of the treatment media 135. Also, in addition to the one nested band of distribution media 130 of stone and column of inner treatment media 135 shown in FIG. 2, embodiments may have several bands of sand and stone in infiltration fields and may have several bands of treatment media, as is, for example, shown in numerous other figures herein. The treatment media (sand, etc.) and distribution media (stone, etc.) may have various widths, shapes, heights, and relative positions in embodiments.

In embodiments, bands of an infiltration field (treatment media and infiltration media) may be separated from each other by material such as geotextile fabric or other material, the outermost band of treatment or distribution material may be separated from placed media 255 by material such as geotextile fabric or other material, and the entire infiltration field may be separated from native soil (in-situ soil) 275 or other existing material by material such as geotextile fabric or other material, as well. The treatment media of embodiments, which may be in circular bands, linear bands, s-shaped bands, etc., may be one or a member of a plurality, and may be nested with other similarly or differently shaped bands of treatment media and distribution media. The bands of treatment media may be approximately four to approximately eighteen inches or more in width while the distribution media, which itself may be one or a member of a plurality and may be in bands or other shapes like the treatment media, may be narrower, with widths of approximately three-quarters of an inch to approximately four inches. The treatment media bands may be vertically elongated, i.e., have a height to width aspect ratio of 2 or greater.

The depth of a vertically elongated infiltration field can vary. For example, the depth of a vertically elongated infiltration field may be at least twice the overall width of the infiltration field. For example, if an infiltration field is twenty-four inches wide then it may be four feet or more in depth. Similarly, the depth of a band of treatment media or a band of distribution media, may be at least approximately twice the overall width of the band of treatment media. For example, if a band of treatment media is two inches wide then it may be four inches or more inches deep. Treatment media may comprise soil (e.g., sand) or diatomaceous earth, perlite, peat, wood-based media or other carbon source, or other media capable of treating water in embodiments. The distribution media, in embodiments, may comprise plastic aggregate, stone aggregate, concrete aggregate, three-dimensional grids (such as stringy fabric mat, cuspated material) as well as other materials that are preferably structurally supportive materials and/or that can preferably provide a porosity greater than the porosity of the treatment media.

In embodiments, if a leaching structure is present, the structure itself of such an infiltration field may support all or a majority of the overburden, static loads, and live loads while the distribution media and the treatment media do not have to be positioned and supported to bear overburden, live loads, or static loads. In embodiments where a leaching structure is not present, the distribution media and the treatment media may be positioned, configured, and/or supported to bear overburden, live loads, or static loads.

While a circular configuration is shown in FIG. 2, other configurations for the treatment media, the distribution media, and leaching structures themselves may also be employed. Moreover, in embodiments, the bands and the leaching structure itself may not employ the same cross-section. In other words, a square leaching structure may contain, for example, inner oval and rectangular bands of treatment media and distribution media. A round configuration or leaching structure on the outside may have straight distribution and treatment bands on the inside. A leaching structure of embodiments may comprise various materials including concrete, metal, fiberglass, and/or plastic. While the distribution media 130 band shown in FIG. 2 is connected, i.e., an entire circle, in other embodiments, a band may not be completely connected to itself. In other words, in embodiments, a band may be in the shape of a horseshoe or a “C” or a “J” or another shape with an open section along its outer perimeter, its inner perimeter, or both.

FIG. 1 shows geotextile fabric, such as filter fabric, 140 between each interface of the infiltration fields 120 and 125, except that infiltration field 125 has no geotextile fabric at the bottom. However, in some embodiments, geotextile fabric may not be employed. For example, no geotextile fabric might be employed between the interface of the native soil and the concrete outer wall of a leaching structure. Likewise, no geotextile fabric may be present between one or more of the interfaces between treatment media and distribution media. In embodiments, the geotextile fabric may include an inner portion and an outer fabric, membrane, and other hygroscopic and non-hygroscopic materials.

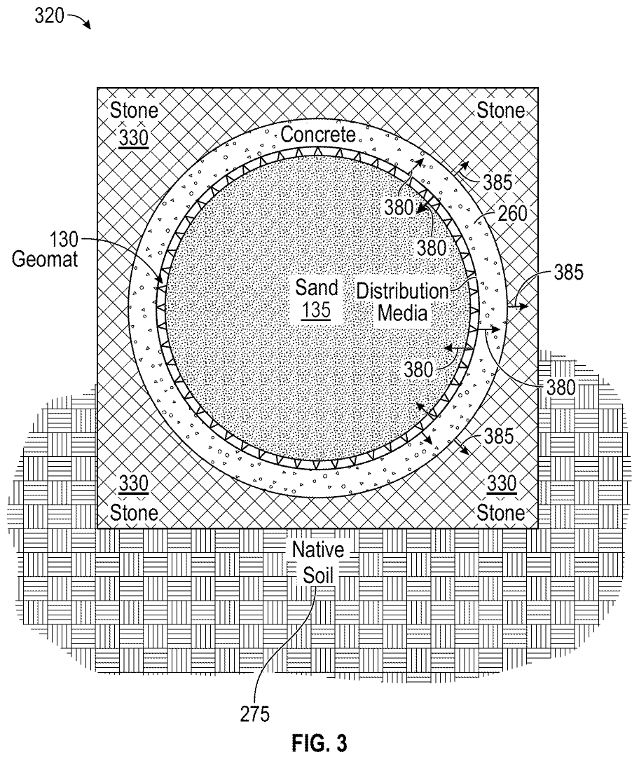

FIG. 3 shows a cross-sectional view of an infiltration field 320 with leaching structure 260 and a single band of distribution media 130 of geomat or other non-aggregate material, surrounding treatment media 135, which may comprise sand and/or soil. Arrows 380, perpendicular to the single band of distribution media 130, illustrate general water flow direction from the distribution media 130 into the treatment media 135. As can be seen, the water flow is both inward to the treatment media 135 and outward, through the leaching structure 260, and towards the native soil 275 in which the infiltration field 320 is placed. Although native soil 275 is shown, placed material may also be employed. Likewise, although sand/soil is illustrated, other treatment media 135 may be employed. The arrows 385 indicate water flow direction after passing through the leaching structure 260 and into distribution media 330, which may be stone or other distribution media. Arrows 380 indicate water passing inwardly and outwardly from the distribution media band of Geomat 130. While perpendicular arrows are shown, these are schematic arrows; in use, flow may not necessarily occur in a purely or solely perpendicular direction.

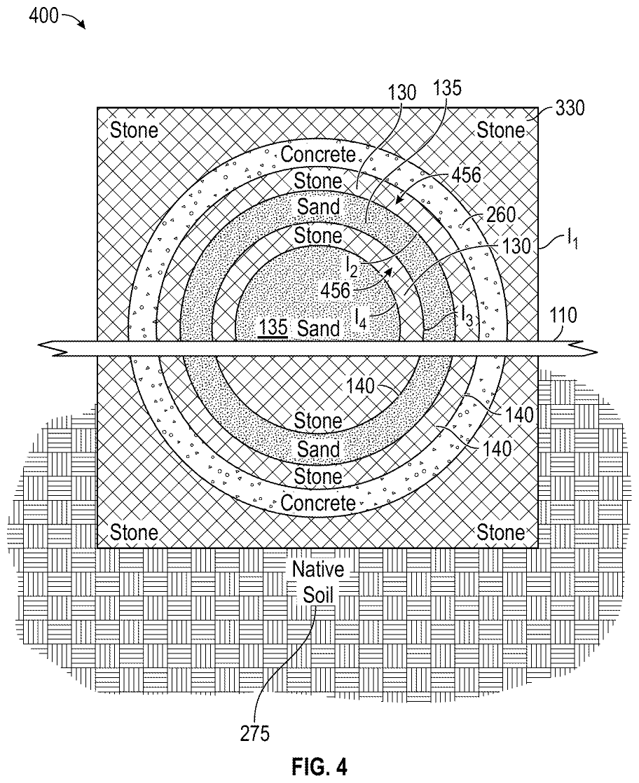

FIG. 4 shows a top view of an infiltration field 400 with a leaching structure 260, which may be concrete, as may be employed in embodiments. This top-down view shows a band of treatment media 135, a central column of treatment media 135, and multiple bands of distribution media 130. A dosing conduit 110 is shown above the bands of treatment media and distribution media of the leaching structure 260. Distribution media 330, which may be stone, is shown adjacent to the leaching structure 260. An array of infiltration surfaces, nos. I₁ through I₄ are labelled in FIG. 4. The distribution media 130 is shown a full circle flow channel 456 in FIG. 4. In other words, water present in the distribution media 130 may flow in a circular fashion within either of the circular cross-sections of the two bands of distribution media shown in FIG. 4 before passing out of the distribution media. Also shown is sand or soil as treatment media 135 in FIG. 4. This treatment media 135 is shown as a nested treatment media band and a central column of treatment media 135. Geotextile fabric 140 is present and borders stone and sand bands in FIG. 4. Thus, the interfaces between treatment media and distribution media may comprise geotextile fabric in embodiments.

In FIG. 4, the distribution media bands and treatment media are bordered by shared interfaces 11-14. These interfaces may be considered infiltration surfaces in which water may pass between media and may be treated via the passage and while within the treatment media. The bands of sand or soil or other treatment media may have depths that are at least approximately twice their width. However, treatment media bands may have shorter depths relative to their widths as well. These can include depths of approximately 1.1, 1.2, 1.3, 1.4, 1.5, 1.6, 1.7, 1.8, and 1.9 times the width of the treatment media band. Treatment media bands can be vertically elongated and can have larger height to width aspect ratios. These ratios, of height to width may be 2, or three, or five, or ten or twenty or larger. Larger aspect ratios for vertically elongated treatment media bands may be used as the larger aspect ratios can provide for greater infiltration area per lot above ground plan surface area. Although sand/soil is illustrated, other treatment media may be present in each treatment media band. Likewise, although stone is shown in FIG. 4, other distribution materials may be employed. Native soil 275 is shown outside the leaching structure 260; however, placed material may also be employed in embodiments.

FIG. 5 shows a top view of an infiltration field 400 without a leaching structure as may be employed in embodiments. This top-down view shows bands of treatment media 135 and distribution media 130. A dosing conduit is present above the bands of treatment media and distribution media of the infiltration field 400 but is not shown for clarity. Native soil 275 is shown adjacent to the outermost band of treatment media 130. An array of infiltration surfaces, nos. I₁ through I₅ are labelled in FIG. 5. Circular flow channels 456 comprising the distribution media 130, are labelled in FIG. 5. Also shown is sand or soil as treatment media 135 in each nested treatment media band and the central column of treatment media. Geotextile fabric 140 is present and borders treatment media and distribution media bands of the infiltration field 400 of FIG. 5. Thus, nested infiltration bands of distribution media 130 are bordered by geotextile fabric in each instance. In FIG. 5, infiltration bands of distribution media and treatment media bands are bordered by shared interfaces I₁-I₅. Similar to FIG. 3, arrows illustrate the flow of water into and out of the bands and central column. While perpendicular arrows are shown, these are schematic arrows; in use, flow may not necessarily occur in a purely or solely perpendicular direction. The bands and/or central column of sand or soil or other treatment material may have depths that are at least approximately twice their width. However, treatment material may be shaped to have shorter depths relative to their widths as well. These can include depths of approximately 1.1, 1.2, 1.3, 14, 1.5, 1.6, 1.7, 1.8, and 1.9 times the width of the treatment material. Treatment media bands can be vertically elongated and can have larger height to width aspect ratios. These ratios, of height to width may be 2, or three, or five, or ten or twenty or larger. Larger aspect ratios for vertically elongated treatment media bands may be used as the larger aspect ratios can provide for greater infiltration area per lot above ground plan surface area. Although sand/soil is illustrated, other treatment media may be present as well. Likewise, although Geomat, stone, etc. are shown in FIG. 5 as distribution media 130, other materials may be employed. Native soil 275 is shown outside the outermost band of treatment media 135, however, placed material may also be employed.

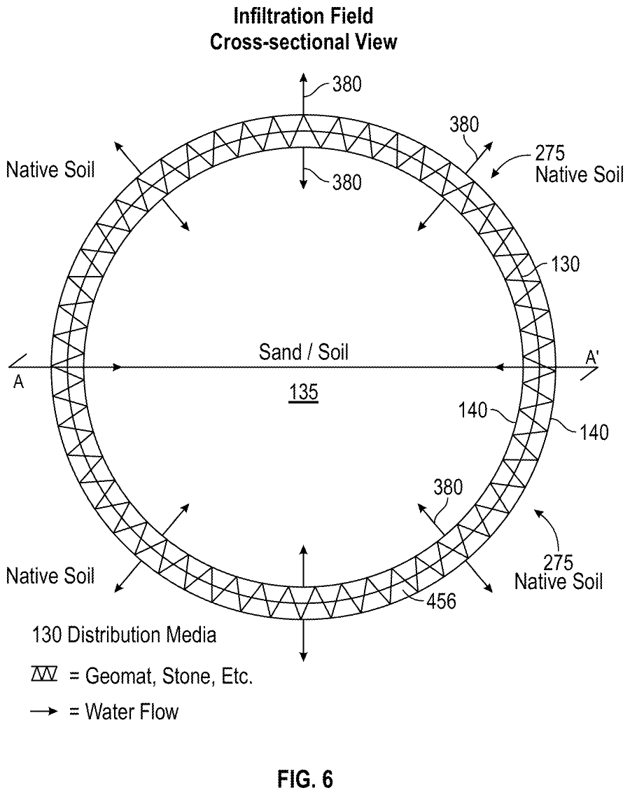

FIG. 6 shows a top view of an exemplary infiltration band as may be employed in embodiments. Water flow arrows 380 and 385 are shown to illustrate how water present in the distribution media 130 of a flow channel 456 band may flow within the band then outward through filter fabric 140 of the distribution media 130 and into the native soil 275 outside and/or inward into the sand/soil treatment media 135 inside the flow channel 456 of treatment media 130. While perpendicular arrows are shown, these are schematic arrows; in use, flow may not necessarily occur in a purely or solely perpendicular direction. In this embodiment, as well as in others, the native soil, as well as the sand/soil treatment media 135, may also serve as treatment media. Likewise, placed media 255, if present, may serve a function depending on its composition; e.g., placed sand/soil may function as treatment media, while placed stone may function as distribution media. Geotextile fabric 140 lies along an infiltration surface on the outer facing surface of the distribution media 130 flow channel 456 and the inner facing surface of the distribution media 130 flow channel 456.

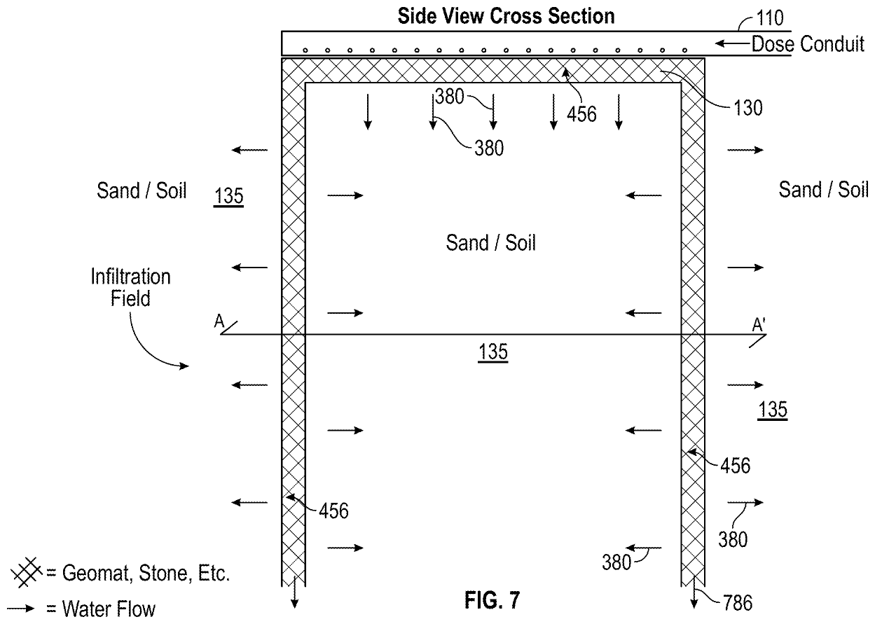

FIG. 7 shows a cross-sectional view along line A-A′ of FIG. 6. As can be seen, distribution media 130 lies underneath the dosing conduit 110 in a horizontal orientation. Distribution media 130 is also positioned in a vertical orientation with treatment media 135 located on either side. Also noticeable is that there is no bottom distribution media, rather, the cross-sectional view in FIG. 7 shows an inverted U shape for the flow channel created by the treatment media. However, embodiments may employ numerous cross-sectional shapes for the bands of distribution media and the bands of treatment media. These cross-sectional shapes may include “D” shapes; “U” shapes; “P” shapes' “T” shapes; “Y” shapes, and numerous other configurations. Arrows 380 show the direction of water flow in the system: first through the dosing conduit 110 and then to the distribution media 130 and out from the distribution media 130 and into treatment media 135. While perpendicular arrows are shown, these are schematic arrows; in use, flow may not necessarily occur in a purely or solely perpendicular direction.

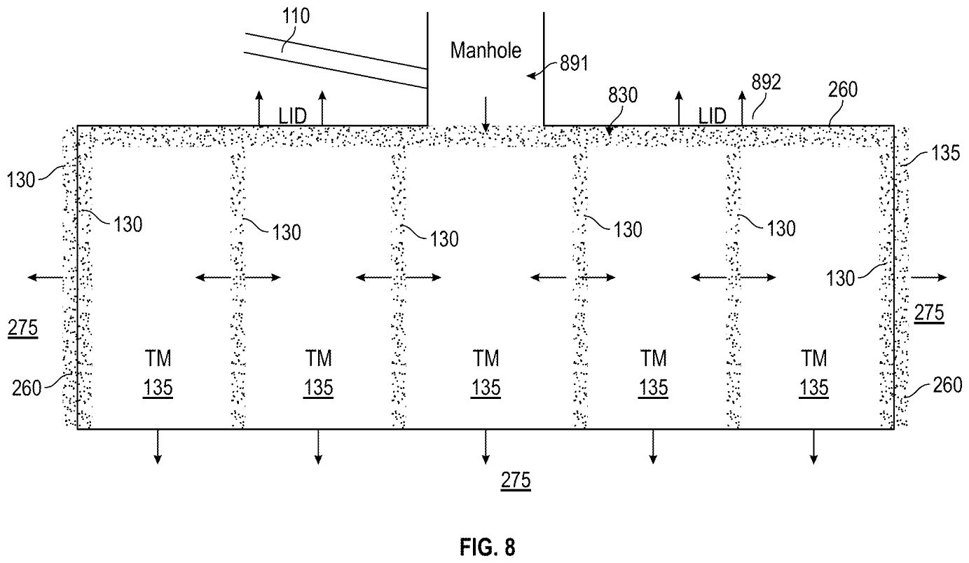

FIG. 8 shows a vertical cross-sectional view of an infiltration field with multiple bands of treatment media 135 and distribution media 130 positioned within a leaching structure 260, which may be concrete walled. Also shown is a distribution media layer 830 below an upper surface of the leaching structure 260, a man hole access 891, a dosing conduit 110 and an access lid 892 in an upper surface of the leaching structure 260. Native soil 275 is shown outside the leaching structure; however, placed material may also be employed. Water to be treated may flow through the dosing pipe and into the man hole access where it then passes through the top layer of stone (distribution media) and into the bands of distribution media and treatment media packed into the leaching structure walls and below the top layer of stone. Although sand and stone are shown in FIG. 8, other materials may be employed. The water may pass though the treatment media, being treated, and ultimately out through walls or the bottom of the structure and into surrounding soil. Similar to FIG. 7, arrows illustrate the flow of water. While perpendicular arrows are shown, these are schematic arrows; in use, flow may not necessarily occur in a purely or solely perpendicular direction. Some dry wells or other leaching structures may have a concrete bottom or other bottom material. These bottom materials may be permeable to water in some embodiments and not permeable to water in other embodiments. Distribution media may be configured in bands or other flow channels to direct and control the amount of water reaching treatment media and to promote that all water reaches a minimum amount of treatment media and infiltrative surface area. As can be seen in FIG. 8, the treatment media may be different heights and thicknesses, uniform and non-uniform, within the infiltration field, and the treatment media may be bounded on some or all sides with material such as geotextile fabric. Likewise, the distribution media may have different configurations (heights, thicknesses, etc.) within the infiltration field. The infiltration field may be bounded on some or all sides with material such as geotextile fabric. FIG. 8 does not show a bottom on the infiltration field, but in some embodiments the infiltration field may have a discrete bottom of permeable or nonpermeable material.

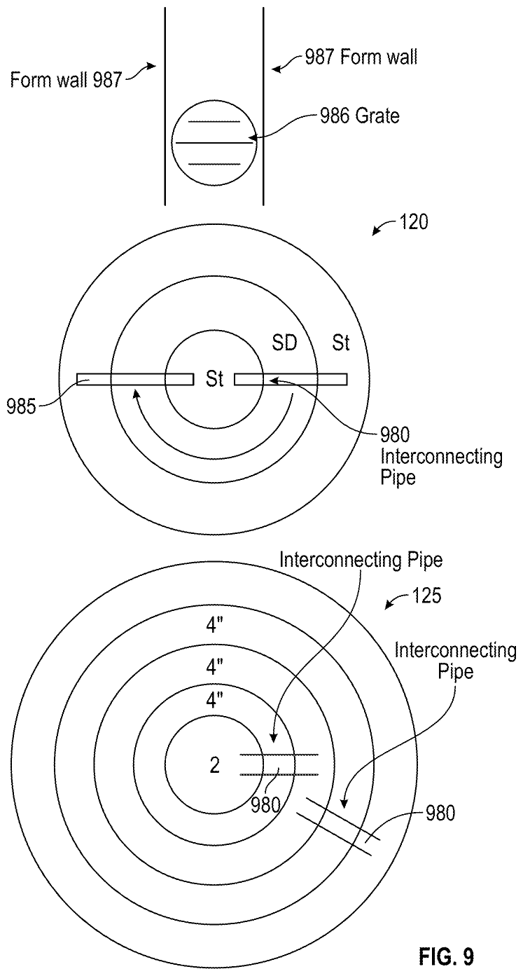

FIG. 9 shows a schematic top view of infiltration fields 120 and 125 with equalization channels 980 and 985 as may be employed in embodiments. Equalization channels 980 and 985 of embodiments can promote the transfer of water between bands of the infiltration field. These equalization channels may provide for redistribution of water between bands of treatment media and distribution media, particularly if one or a grouping of bands of treatment media and/or distribution media is overloaded with water and/or has a greater amount of water than other bands of an infiltration field. The equalization channels may comprise conduits piercing through a band of treatment media and connecting two bands of distribution media. Also, the equalization channels may connect other bands of media, for instance, two bands of treatment media and/or while also passing through a wall of a leaching structure. In so doing, the equalization channels may serve to manage water loading in and around an infiltration field. Where water levels are higher in one section of an infiltration field this water may be diverted to another area of the infiltration field via one or more equalization channels. Some equalization channels may have surface access, such as the grate 986 corresponding to the location of the equalization channel 985. Numerals 987 show form walls in which a grate 986 may be positioned between . . . .

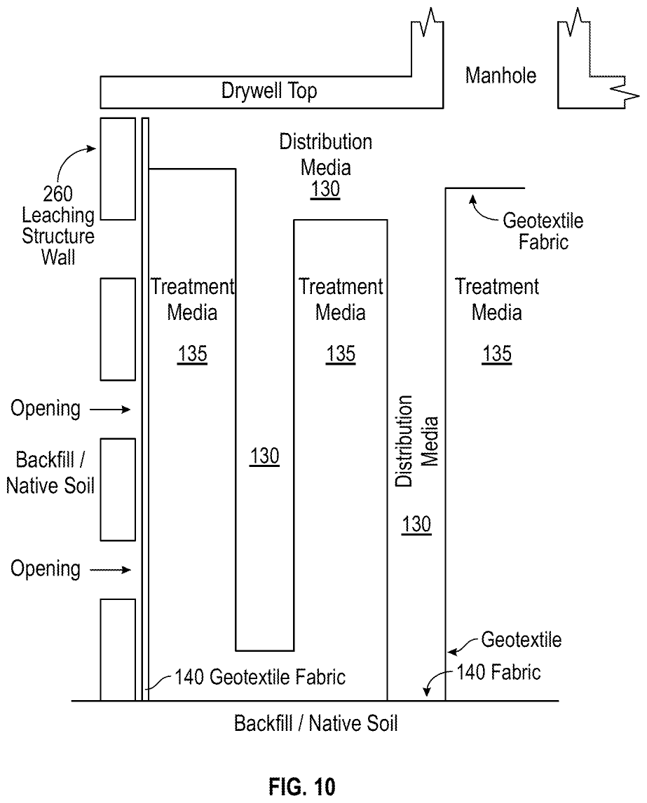

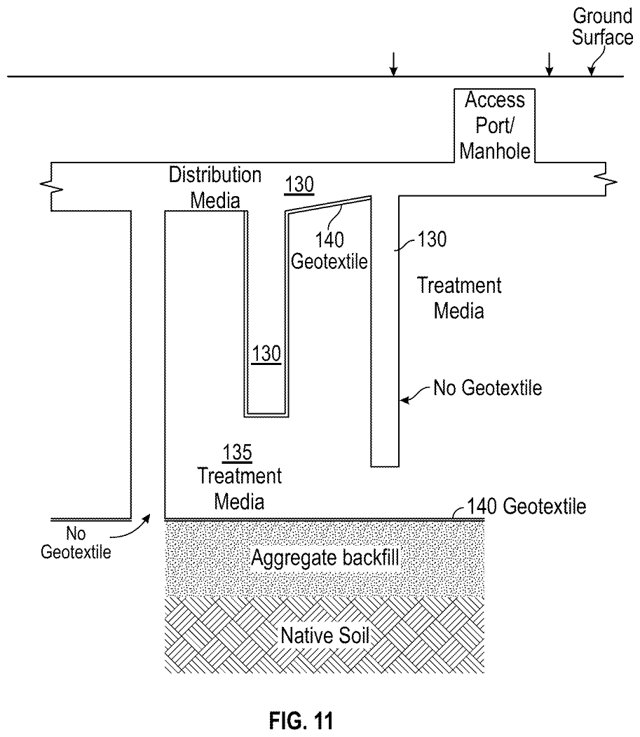

FIGS. 10-11 show cut-away views of a section of an infiltration field with leaching structure 260 as may be employed in embodiments. As can be seen, the wall of the leaching structure may have passages in embodiments that allow water to pass from within the structure to outside of the structure. These passages may be covered with geotextile fabric, such as a filter fabric, or another material. The leaching structure 260 may also have a top and manhole(s) for access. This top may be positioned during installation and, preferably, after the treatment media 135 and distribution media 130 have been placed in the structure. As can be seen, the treatment media 135 can be different heights and thicknesses within the leaching structure 260, and the treatment media may be bounded on some or all sides with material such as geotextile fabric 140. Likewise, the distribution media 130 may have different configurations (heights, thicknesses, etc.). In embodiments, leaching structure(s) may be bounded on some or all sides with materials such as geotextile materials and fabrics. FIGS. 10-11 do not show a bottom on the leaching structure 260, but in some embodiments the leaching structure 260 may have a permeable or non-permeable bottom comprised of concrete or other material.

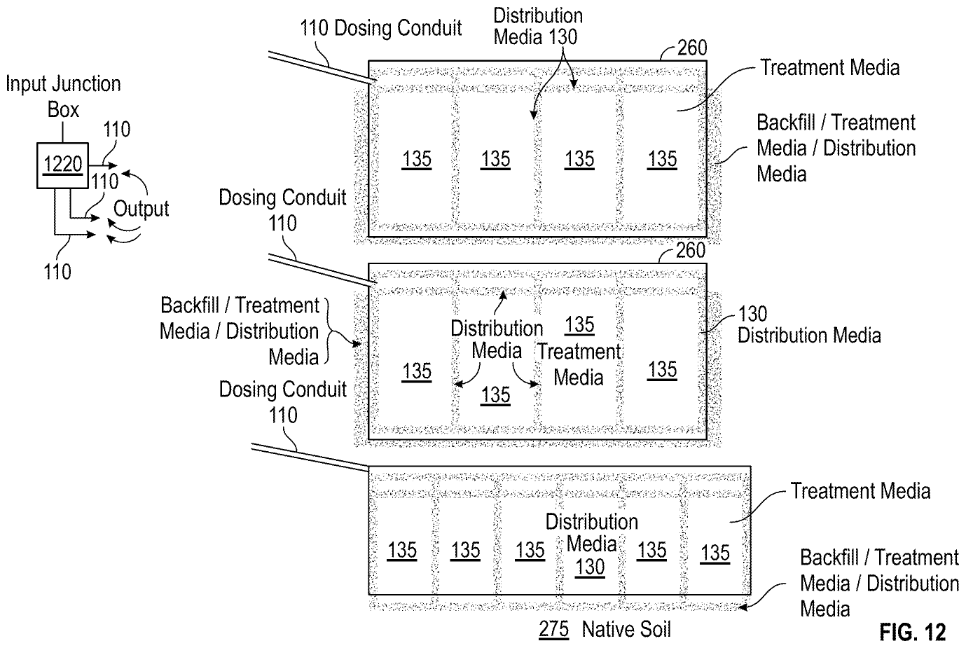

FIG. 12 shows a water treatment system with infiltration field having multiple stacked leaching structures 260 as may be employed in embodiments. As can be seen, the leaching structures 260 may be stacked atop one another and may be fed water through individual dosing conduits 110. These dosing conduits 110 may be connected to each other in series or parallel. Water entering the top leaching structure may cascade down through each leaching structure in embodiments. In other embodiments, water exiting a higher leaching structure maybe channeled away from the next lower leaching structure, rather than entering it. In other words, the lower treatment structures may treat water only from the specific dosing pipe serving each lower treatment structure, or may treat water received from the specific dosing pipe connected to the lower structure and also treat water previously treated by other, higher-placed, leaching structures of the infiltration system. A junction box 1220 may be employed to direct water to only one to the dosing conduits 110 such that an equal amount of water loading may be received by each of the three stacked leaching structures and related treatment media.

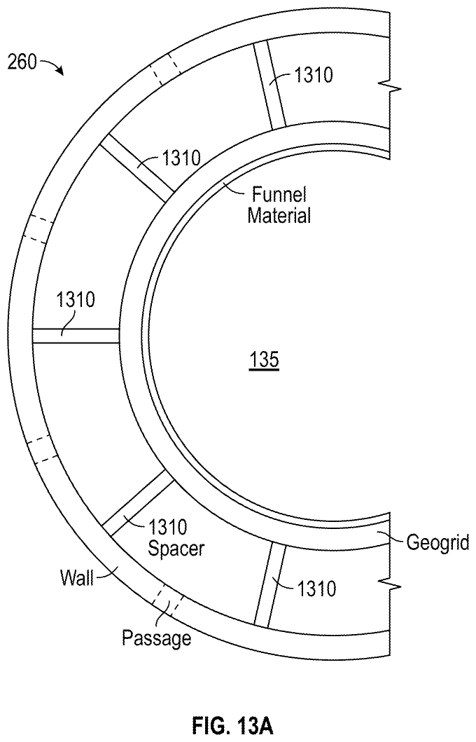

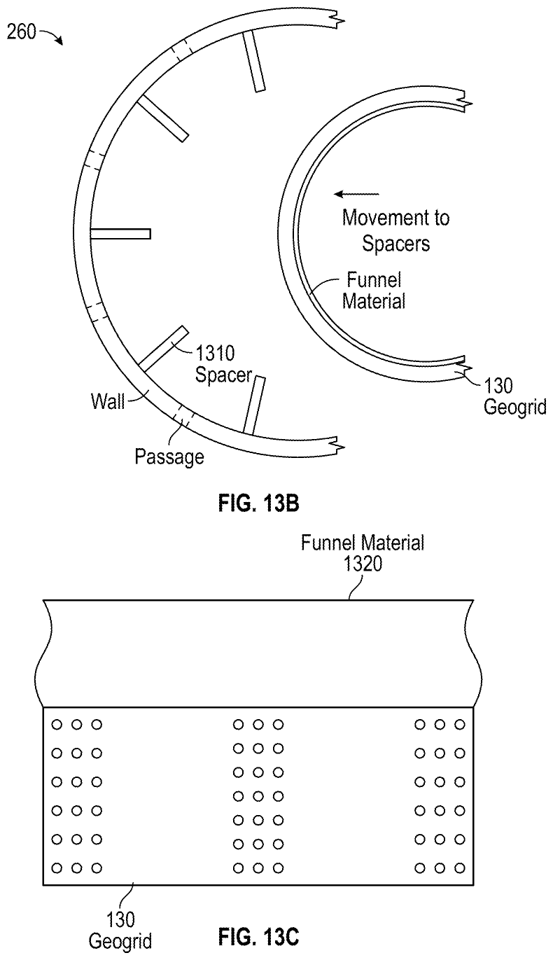

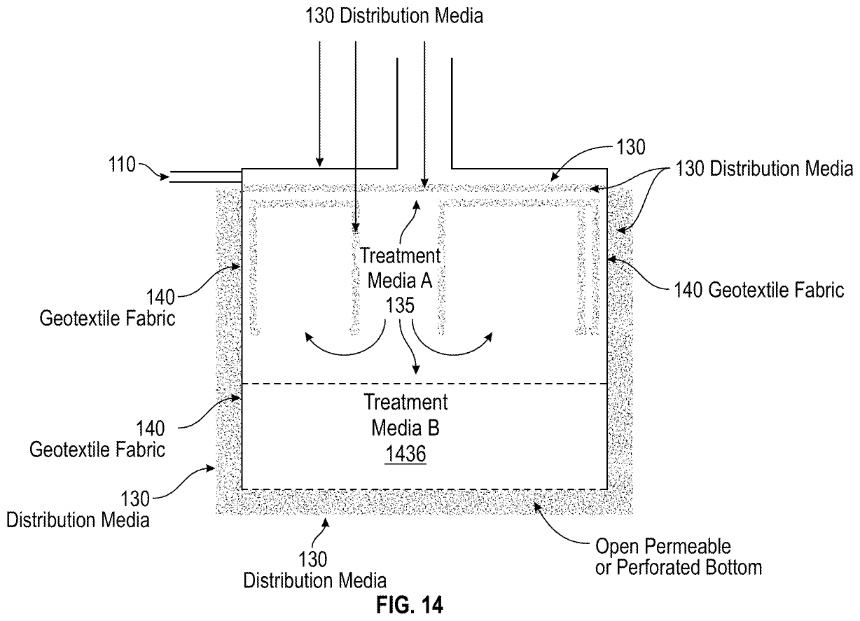

FIGS. 13A-13B show an example of a leaching structure 260 with spacers 1310 and how these spacers 1310 can be employed when aligning a geogrid or other distribution media 130 within the leaching structure 260 of an infiltration field. One or more geogrids or other bands of distribution media may be positioned within the leaching structure 260 using spacers 1310. Once positioned, the treatment media 135 may be added to the leaching structure. A funneling material 1320, illustrated in FIG. 13C, such as a geotextile fabric may be connected to the geogrid distribution media 130 and may be held above the leaching structure 260 in order to serve as a funnel for placing loose treatment media into gaps between the walls of the leaching structure and geogrid or other distribution media 130. Once placed, the loose treatment media, such as sand or another soil, would be situated in the form of the bands described herein. After the treatment media is placed, the funneling material may be detached from the geogrid or other distribution material to which the funneling material is attached or secured.

As shown in FIGS. 13A-13B, permanent and removable spacers 1310 may be employed to maintain band distance during installation. These spacers 1310 may be polymer, carbon, glass, steel, aluminum, and cardboard, among other things.

FIGS. 13A and 13B show a leaching structure with spacers before (FIG. 10A) and after (FIG. 10B) a geogrid, serving as a distribution media, is located within the leaching structure. The geogrid, which may comprise a three-dimensional grid identified above, may be held away from the inner walls of the leaching structure by the spacers and this space between the geogrid and the spacers may be filled with treatment media. This assembly of the leaching structure with the geogrid and the treatment media may occur in phases and may take place while the leaching structure is out of the ground, in the ground, or installed at its final location. In other words, the leaching structure may be partially or fully assembled with treatment media and distribution media before or after the leaching structure is placed in the ground. While one band of geogrid shown in FIGS. 13A and 13B, additional bands may also be employed in embodiments.

FIG. 13C shows an elevation view of a geogrid with funnel material 1320 as may be employed in embodiments. During assembly, this funnel material may be propped up and used to channel or funnel treatment media into open areas in order to form bands of treatment media in the leaching structure. As noted above, during assembly, the geogrid may be moved into position and held there by the spacers. Once positioned, the funnel material may be unfolded and opened up such that the funnel material can guide and channel treatment media into open areas between the geogrid and the leaching structure wall or another distribution media band. Funnels can also be configured specifically for this task.

FIG. 14 shows a cross-sectional side view of an infiltration field with treatment media A 135, treatment media B 1436, and distribution media 130. As can be seen, in the illustrated embodiment, the distribution media 130 does not reach the full depth of the infiltration field, and the bottom of the infiltration field is open or perforated. A notable feature shown in FIG. 14 is that the distribution media does not reach into the treatment media B 1436. Due to this configuration, water to be treated must travel at least the depth of the treatment media B prior to exiting the infiltration field. In this configuration, water may be treated by treatment media A and then move downwards to be treated by treatment media B. These treatment medias A and B may be the same or different. Thus, in some embodiments, at least some distribution media bands may not extend to the full depth of the infiltration field. Due to this configuration, water passing down would travel through treatment media at least the thickness of treatment media B. This feature may be present in other embodiments as well.

Embodiments may also include bands of treatment media and distribution media outside of the leaching structure wall. In these embodiments, a leaching structure wall may be placed in the ground and bands of distribution media and treatment media may be placed outside of the leaching structure walls.

FIG. 15 shows a cross-sectional view of treatment media, distribution media and a leaching structure wall of an infiltration field as may be employed in embodiments. Here, the leaching structure wall is labelled by A and A′, while treatment media is labelled with B, D, F, and G, and distribution media is labelled with C and E. As can be seen, embodiments may have bands of distribution media or treatment media that are not closed on themselves, i.e., full circles or polygons, or other shapes. Likewise, the leaching structure wall may not be fully closed as well. FIG. 15, for example, shows leaching walls that are different sizes and cumulatively form a majority of the circumference of a circle. Like distribution media and treatment media, other shapes and configurations for leaching structures may also be used. As can also be seen in FIG. 15, the gaps in the various bands may or may not correspond with each other in embodiments. These gaps can be located to promote water flow between bands and in and around a leaching structure system or between leaching structure systems of embodiments.

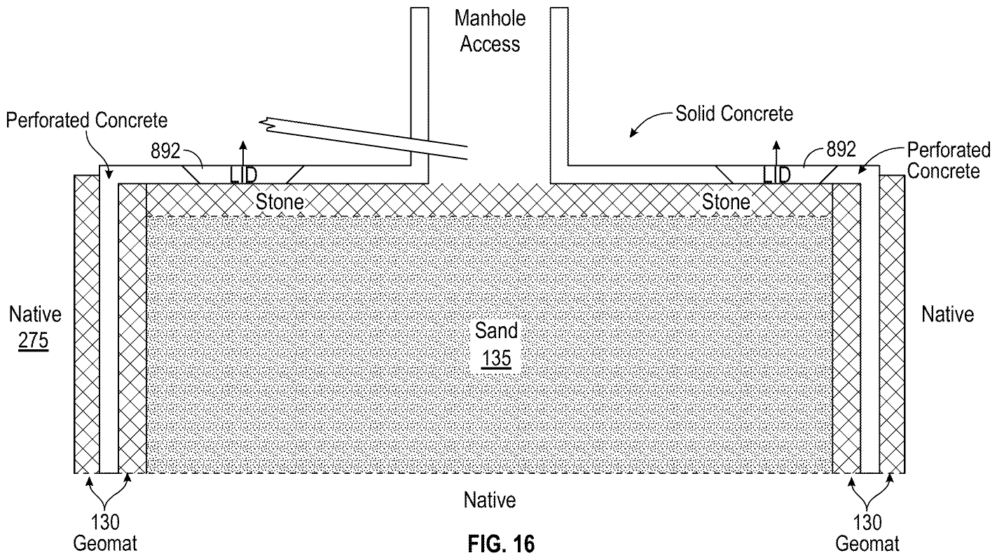

FIG. 16 shows a side elevational cross-section of an infiltration field with leaching structure, treatment media 135 and distribution media 130, as may be employed in embodiments. The distribution media comprises stone near the top of the leaching structure and geonet on the inside and outside of the walls of the leaching structure. Sand, the treatment media, is shown in the center of the leaching structure and above native material. The walls of the leaching structure are shown with perforated concrete and similar functioning materials, as may be employed in this or other embodiments. The geonet and the stone, each distribution media, is shown in FIG. 16, along with a solid concrete top surface and perforated concrete side walls are shown. The geonet distribution media is shown inside and outside the perforated concrete structural walls in this figure. Access lids 892 are also shown.

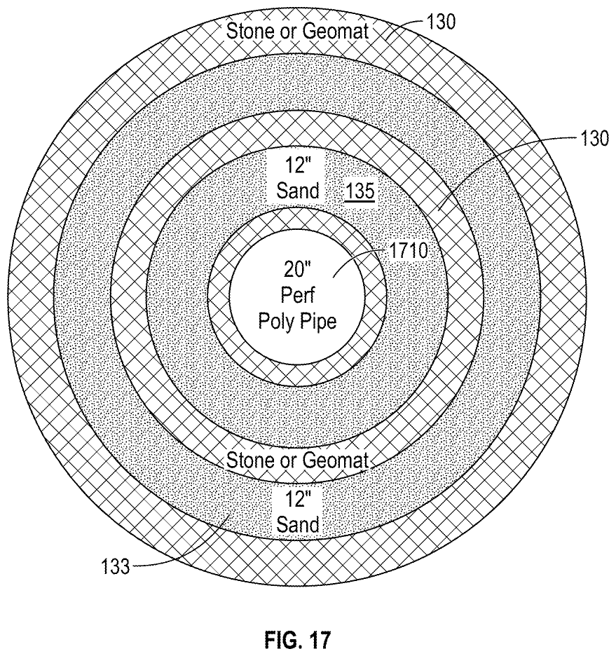

FIG. 17 shows a cross-sectional view of bands of treatment media and distribution media surrounding an internal perforated polymer conduit 1710 as may be employed in embodiments. In this embodiment, the polymer conduit 1710 serves as a leaching structure and can provide rigidity as well as a void during construction and/or as permanently, while the system is in operation. FIG. 17 shows a 20-inch diameter perforated polymer conduit 1710, but other diameters may be employed, such as approximately 5 inches, approximately 6 inches, approximately 10 inches, approximately 15 inches, approximately 20 inches, approximately 24 inches, or other diameters as well. Similarly, FIG. 17 shows treatment media bands of sand having a width of 12 inches; other widths and other treatment media may be employed. Likewise, FIG. 17 shows a distribution media band of stone or geomat; other distribution media may be employed. Carbon containing band treatment media, may also be employed in embodiments. In embodiments, carbon bands may comprise blended material comprising a carbon source and another material.

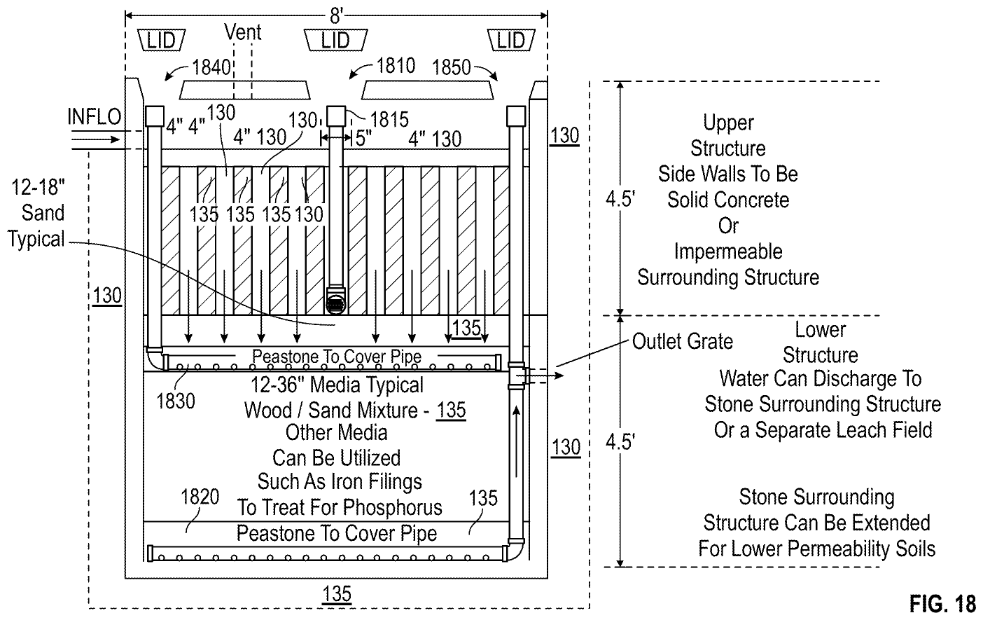

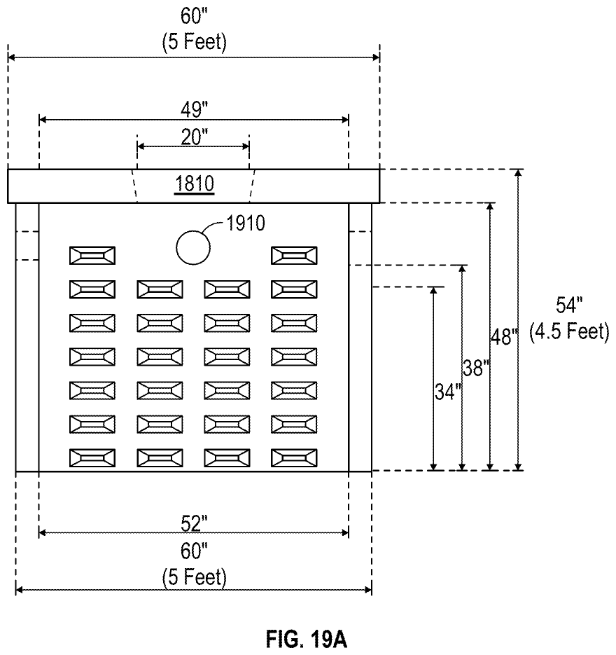

FIG. 18 shows a side cross-sectional view of an infiltration field with leaching structure as may be employed in embodiments. As can be seen, the access opening 1810 contains an inspection port 1815 for access below the top surface of the 4″ distribution media 130 and into the lower regions of the treatment media 135 and distribution media 130 bands. Thus, the inspection port 1815 allows for monitoring of water levels as well as for sampling of water quality, carbon source status, and for other sampling near or at the lower regions of the system as well. Also labelled in FIG. 18 are the lower sampling conduit 1820 and the upper sampling conduit 1830. Optional vacuum port 1840 and optional sample port 1850 are also labelled in FIG. 18. FIG. 18 shows an upper structure of the infiltration field with solid concrete sidewalls or other impermeable liner and a lower structure with an outlet grate that permits discharge of water outside of the structure. Whereas certain exemplary dimensions and materials are depicted in FIG. 18, other dimensions and materials may be employed.

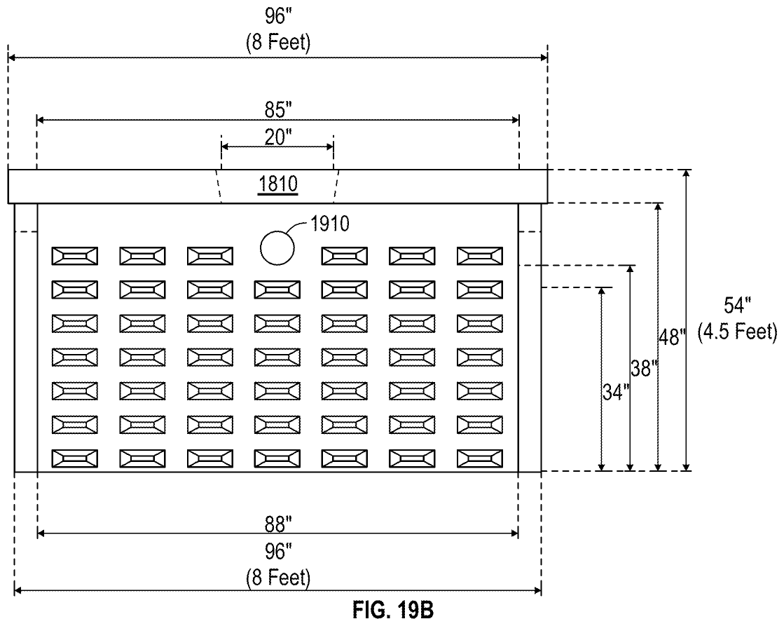

FIG. 19A shows a side view of a leaching structure as may be employed in an infiltration field of embodiments. As can be seen, the structural walls are formed to contain rectangular passages and these passages are spaced apart from each other and may be arranged in two-dimensional arrays in embodiments. Dosing conduit passage 1910 and access opening 1810 are also visible in this elevation view. Whereas certain exemplary dimensions are depicted in FIG. 19A, other dimensions may be employed.

FIG. 19B shows a side view of a leaching structure as may be employed in an infiltration field of embodiments. As can be seen, the structural walls are formed to contain rectangular passages and these passages are spaced apart from each other and may be arranged in two-dimensional arrays in embodiments. The dosing conduit passage 1910 and access opening 1810 are also visible in this elevation view. Whereas certain exemplary dimensions are depicted in FIG. 19B, other dimensions may be employed.

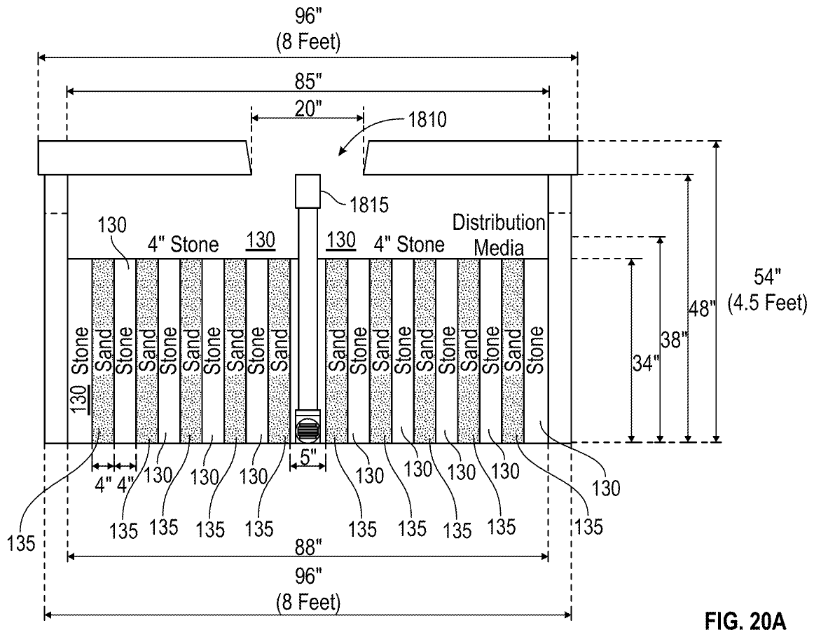

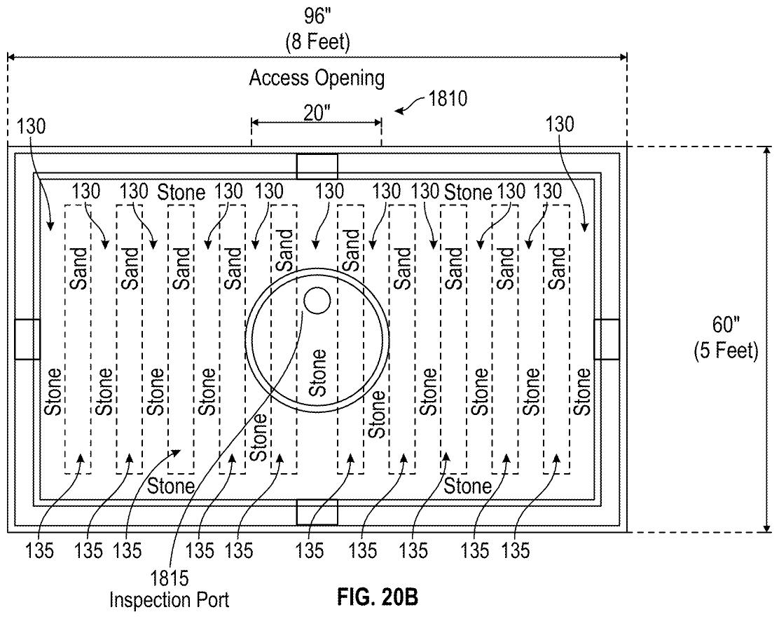

FIG. 20A shows a side cross-sectional view of an infiltration field as may be employed in embodiments. As can be seen, the access opening 1810 contains an inspection port 1815 for access below the top surface of the 4″ distribution media 130 and into the lower regions of the treatment media 135 and distribution media 130 bands. Thus, the inspection port allows for monitoring of water levels as well as for sampling of water quality, carbon source status, and for other sampling near or at the lower regions of the infiltration field as well. Visible in FIG. 20A are the multiple alternating bands of treatment media and distribution media. Thus, bands of these media may not only be curved, as explained above, but may also be linear, and other shapes as well. The height and width of the bands of treatment media and distribution media are visible in this side view. Whereas certain exemplary dimensions and materials are depicted in FIG. 20A, other dimensions and materials may be employed.

FIG. 20B shows a top view of the infiltration field of FIG. 20A as may be employed in embodiments. The bands of treatment media and distribution media within a stone perimeter and structural walls can be seen in this figure. The location of exemplary inspection port may also be seen in this view. The access opening 1810, which may be removed for access and replaced when in use or when access is not needed, is labelled along with the inspection port 1815. The length and width of the bands of treatment media and distribution media are visible in this top view. Whereas certain exemplary dimensions and materials are depicted in FIG. 20B, other dimensions and materials may be employed.

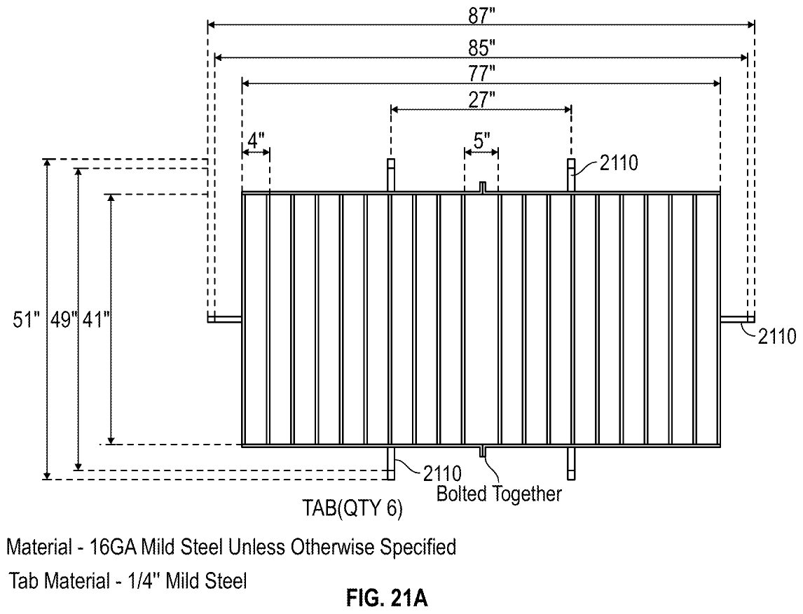

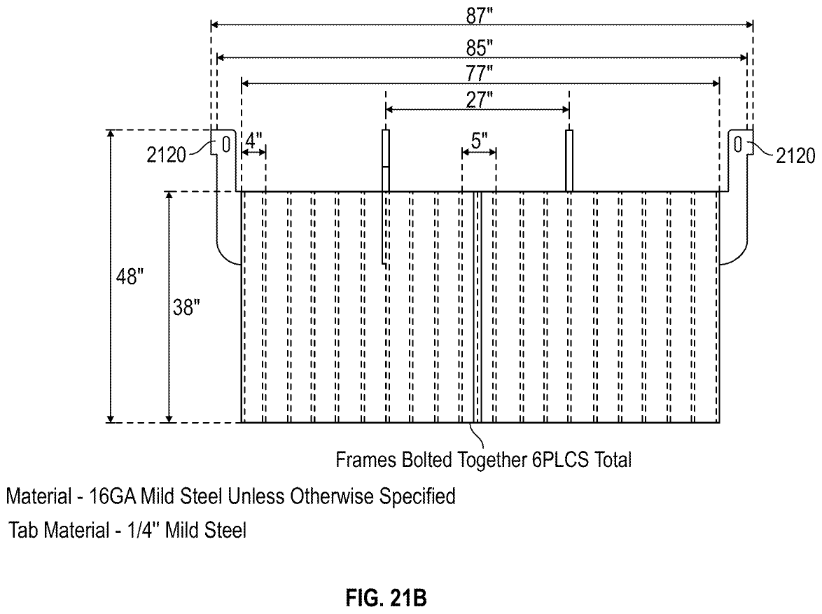

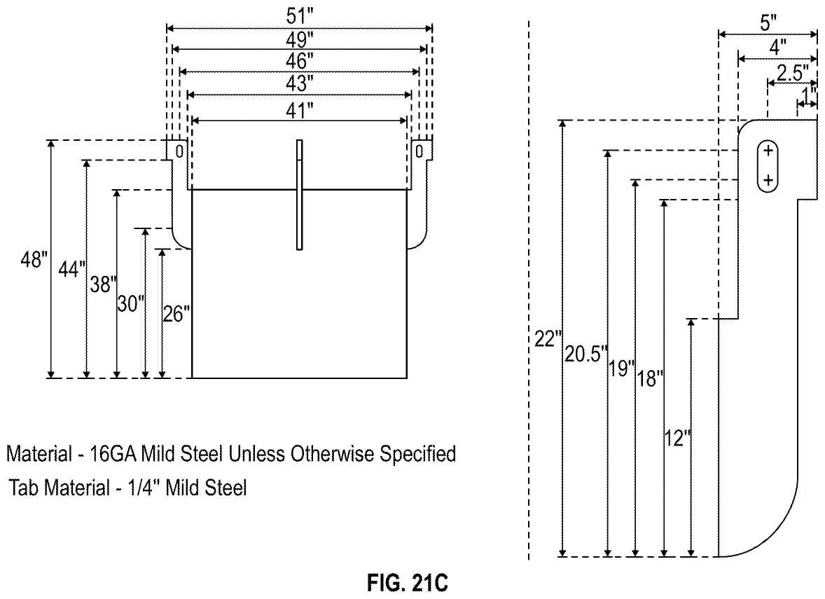

FIG. 21A shows a top view of formwork that may be employed to shape bands of distribution media and treatment media in embodiments. The formwork may comprise individual slats that can be assembled into the form and placed in an excavation to be subsequently filed with treatment media and distribution media. External spacers or tabs 2110 may be present to provide a gauge for a minimum distance between the formwork and an excavation. this minimum distance may be filled with distribution media in embodiments. Whereas certain exemplary dimensions and materials are depicted in FIG. 21A, other dimensions and materials may be employed.

FIG. 21B shows a side view of formwork that may be employed to shape bands of distribution media and treatment media in embodiments. This side view shows arms 2120, which may be used of lower the formwork into an excavation or remove the formwork once backfilled with treatment media and distribution media. Whereas certain exemplary dimensions and materials are depicted in FIG. 21B, other dimensions and materials may be employed.

FIG. 21C shows a side view and tab detail of formwork components that may be employed to shape bands of distribution media and treatment media in embodiments. These components may be used as individual separators to divide bands of treatment media and distribution media placed into the formwork. Whereas certain exemplary dimensions and materials are depicted in FIG. 21C, other dimensions and materials may be employed.

Whereas certain exemplary dimensions and materials are depicted in certain of the Figures, unless otherwise specified or required, other dimensions and materials may be employed.

The preceding detailed description is merely illustrative in nature and is not intended to limit the embodiments of the subject matter of the application or uses of such embodiments. Numerous embodiments are possible beyond those specifically described above and below. The embodiments described here are illustrative and should not be considered to be limiting. This includes that the processes described herein may be undertaken in various orders unless a specific order is called for in the applicable claim or description. Moreover, fewer or more features or actions may accompany those specifically described herein. Likewise, disclosed embodiments, whether in the brief summary or detailed description may be further modified, including being altered using features and processes selected from different embodiments and using features and processes in different orders and configurations.

The preceding detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Any appearance of the phrases “in one embodiment” or “in an embodiment” do not necessarily refer to the same embodiment. Particular features, structures, or characteristics may be combined in any suitable manner consistent with this disclosure.

While embodiments have been illustrated herein, they are not intended to restrict or limit the scope of the appended claims to such detail. In view of the teachings in this application, additional advantages and modifications will be readily apparent to and appreciated by those having ordinary skill in the art. Accordingly, changes may be made to the above embodiments without departing from the scope of the invention.

It will be further understood that the terms “comprises” and/or “comprising,” when used in this specification, are open ended terms and specify the presence of stated features, integers, steps, operations, elements, and/or components, but do not preclude the presence or addition of one or more other features, integers, steps, operations, elements, components, and/or groups thereof.

“Configured to” connotes structure by indicating a device, such as a unit or component, includes structure that performs a task or tasks during operation, and such structure is configured to perform the task even when the device is not currently operational (e.g., is not on/active). A device “configured to” perform one or more tasks is expressly intended to not invoke 35 U.S.C. § 112, (f) or sixth paragraph.

As used herein, the terms “about” or “approximately” in reference to a recited numeric value, including for example, whole numbers, fractions, and/or percentages, generally indicates that the recited numeric value encompasses a range of numerical values (e.g., +/−5% to 10% of the recited value) that one of ordinary skill in the art would consider equivalent to the recited value (e.g., performing substantially the same function, acting in substantially the same way, and/or having substantially the same result). As used herein, the terms “about” or “approximately” in reference to a recited non-numeric parameter generally indicates that the recited non-numeric parameter encompasses a range of parameters that one of ordinary skill in the art would consider equivalent to the recited parameter (e.g., performing substantially the same function, acting in substantially the same way, and/or having substantially the same result).

Recitation of ranges of values herein are merely intended to serve as a shorthand method of referring individually to each separate value falling within the range, unless otherwise indicated herein, and each separate value is incorporated into the specification as if it were individually recited herein.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

“Improve” or “Promote”—As used herein, improve or promote is used to describe an increasing or maximizing effect. When a component, element, or feature is described as improving or promoting an action, motion, or condition it may produce the desired result or outcome or future state completely. However, when a component, element, or feature is referred to as improving or promoting a result or outcome or state, it need not completely produce the desired result or outcome or state; rather only an increase is required, as compared to the result or outcome or state in the absence of the component, element, or feature. Additionally, “improve” or “promote” can also refer to an increase of the outcome, performance, and/or effect which might otherwise occur, even in the absence of the component or feature.

“Prolong”—As used herein, prolong is used to describe an effect of increase or lengthening of time. When a component, element, or feature is described as prolonging an action, motion, or condition it may produce the desired time increase or lengthening effect as compared to the time the action, motion, or condition would last or endure without the presence of the component, element, or feature.

“Capable of”—As used herein, a material is “capable of” performing an act or achieving an effect when the material performs or achieves as specified at least under certain conditions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

The corresponding structures, material, acts, and equivalents of any means or steps plus function elements in the claims are intended to include any structure, material or act for performing the function in combination with other claimed elements. The description of certain embodiments of the present invention have been presented for purposes of illustration and description, but is not intended to be exhaustive or limited to the invention in the form disclosed. Many modifications and variations will be apparent to those of ordinary skill without departing from the scope and spirit of the invention. These embodiments were chosen and described in order to best explain the principles of the invention and the practical application, and to enable others of ordinary skill in the art to understand the invention for embodiments with various modifications as are suited to the particular use contemplated.

The scope of the present disclosure includes any feature or combination of features disclosed herein (either explicitly or implicitly), or any generalization thereof, regardless of whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The description of the embodiments has been presented for purposes of illustration and description, but is not intended to be exhaustive or limited to the invention in the form disclosed. Many modifications and variations will be apparent to those of ordinary skill without departing from the scope and spirit of the invention. The embodiments were chosen and described in order to best explain the principles of the invention and the practical application, and to enable others of ordinary skill in the art to understand the invention for embodiments with various modifications as are suited to the particular use contemplated.

What is claimed is:

1. An infiltration system comprising:
a first band, the first band comprising treatment media, the first band being vertically elongated and having a height of three feet or more, a width, and a length, the length of the first band forming a non-linear shape, the treatment media having a first porosity;
a second band, the second band comprising distribution media, the second band being vertically elongated and having a height of three feet or more, a width, and a length, the length of the second band forming a non-linear shape, the second band positioned around or within the first band, the second band having a second porosity, the second porosity being greater than the first porosity,
wherein the first band and the second band are positioned within or outside of a drywell comprising a rigid material, the drywell having open passages sized to permit the passage of water from inside the dry well to outside the drywell.

2. The infiltration system of claim 1 wherein the drywell is in the form of a rectangle or circle or square and wherein an interface between the first band and the second band comprises geotextile fabric.

3. The infiltration system of claim 1 further comprising a dosing conduit positioned above the first band and above the second band.

4. The infiltration system of claim 1 further comprising a third band of treatment media, the third band positioned underneath the second band, the third band having a width of no more than four inches, the third band having a height, the third band being vertically elongated and having height being at least twice the third band width.

5. The infiltration system of claim 1 wherein the treatment media comprises sand and a carbon source.

6. The infiltration system of claim 1 wherein the drywell rigid material comprises concrete, steel, polymer, or carbon fiber laminate.

7. The infiltration system of claim 1 wherein the rigid material comprises concrete.

8. An infiltration system comprising:
a first band, the first band comprising treatment media, the first band being vertically elongated and having a height of three feet or more, a width, and a length, the length of the first band forming a linear shape, the treatment media having a first porosity;
a second band, the second band comprising distribution media, the second band being vertically elongated and having a height of three feet or more, a width, and a length, the length of the second band forming a linear shape, the second band positioned around or within the first band, the second band having a second porosity, the second porosity being greater than the first porosity,
wherein the first band and the second band are positioned within or outside of a drywell, the drywell having open passages sized to permit the passage of water from inside the dry well to outside the drywell.

9. The infiltration system of claim 8 wherein the drywell is in the form of a rectangle or circle or square and wherein an interface between the first band and the second band comprises geotextile fabric.

10. The infiltration system of claim 8 further comprising a dosing conduit positioned above the first band and above the second band.

11. The infiltration system of claim 8 further comprising a third band of treatment media, the third band positioned around the second band, the third band having a width of no more than four inches, the third band having a height, the third band height being vertically elongated and being at least twice the third band width.

12. The infiltration system of claim 8 wherein the treatment media comprises sand and a carbon source.

13. The infiltration system of claim 8 wherein the drywell comprises concrete, steel, polymer, or carbon fiber laminate.

14. The infiltration field system of claim 8 wherein the drywell comprises concrete.

15. An infiltration system comprising:
a first band, the first band comprising treatment media, the first band being vertically elongated and having a height of three feet or more, a width, a length, an installation depth of three feet or more, and a cross-sectional shape defined by height and the width, the cross-sectional shape configured as a polygon, wherein the treatment media has a first porosity; and
a second band, the second band comprising distribution media, the second band being vertically elongated and having a height of two feet or more, a width, a length, and a cross-sectional shape defined by the height and the width, the cross-sectional shape configured as a polygon, the second band positioned around or within the first band, the second band having a second porosity, the second porosity being greater than the first porosity.

16. The infiltration system of claim 15 wherein the closed loop is in the form of a rectangle or circle or square and wherein an interface between the first band and the second band comprises geotextile fabric.

17. The infiltration system of claim 15 further comprising a dosing conduit positioned above the first band and the second band.

18. The infiltration system of claim 15 further comprising a third band, the third band positioned underneath the second band, the third band having a cross-sectional thickness of no more than four inches, the third band having a band height and a third band length, the third band height being at least twice the third band width.

19. The infiltration system of claim 15 wherein the treatment media comprises sand, a carbon source, an iron containing substance or a substance for adjusting alkalinity or ph.

20. The infiltration system of claim 15 further comprising a water storage structure positioned below the first band or the second band or both, the water storage structure configured to store water, the water storage structure in fluid communication with a recirculation conduit, the recirculation conduit positioned and configured to extract water from the water storage structure.
